(19) United States
(12) Patent Application Publication
(10) Pub. No.: US 2025/0304096 A1
(43) Pub. Date: Oct. 2, 2025

(54) CONTROL DEVICE, AUTOMATED DRIVING DEVICE, AND TRAVELING CONTROL DEVICE

(71) Applicant: DENSO CORPORATION, Kariya-city (JP)

(72) Inventors: Takuya KUME, Kariya-city (JP); Kazuki Izumi, Kariya-city (JP)

(21) Appl. No.: 19/233,950

(22) Filed: Jun. 10, 2025

Related U.S. Application Data
(63) Continuation of application No. PCT/JP2023/043145, filed on Dec. 1, 2023.

(30) Foreign Application Priority Data
Dec. 16, 2022 (JP) 2022-201441
Oct. 16, 2023 (JP) 2023-178396

(51) Int. Cl. B60W 50/14; B60W 30/14; B60W 40/08; B60W 50/02; B60W 50/029; B60W 50/12; B60W 60/00

(52) U.S. Cl. CPC B60W 50/14; B60W 30/146; B60W 40/08; B60W 50/0205; B60W 50/029; B60W 50/12; B60W 60/0015; B60W 60/0053; B60W 2040/0827; B60W 2050/0215; B60W 2050/0295; B60W 2050/143; B60W 2050/146; B60W 2540/229; B60W 2556/65

(57) ABSTRACT

A control device determines collision occurrence information and vehicle control information indicating control of a vehicle according to a collision, and performs both of a notification indicating a control state of the vehicle and a notification prompting a driver to perform driving takeover to the driver. The control device communicates with an automated driving device or a traveling control device. The automated driving device recognizes the collision and changes a response related to an automated driving control. The traveling control device limits a motion of the vehicle according to the collision.

### CROSS REFERENCE TO RELATED APPLICATIONS

The present application is a continuation application of International Patent Application No. PCT/JP2023/043145 filed on Dec. 1, 2023, which designated the U.S. and claims the benefit of priority from Japanese Patent Application No. 2022-201441 filed on Dec. 16, 2022, and Japanese Patent Application No. 2023-178396 filed on Oct. 16, 2023. The entire disclosures of all of the above applications are incorporated herein by reference.

### TECHNICAL FIELD

The present disclosure relates to a technology for responding to collisions during autonomous traveling of a vehicle.

### BACKGROUND

As a comparative example, a vehicle performs a warning notification indicating that continuation of automated driving is not possible, using a warning method according to a driver state.

### SUMMARY

According to an aspect of the present disclosure, a control device determines collision occurrence information and vehicle control information indicating control of a vehicle according to a collision, and performs both of a notification indicating a control state of the vehicle and a notification prompting a driver to perform driving takeover to the driver. The control device communicates with an automated driving device or a traveling control device. The automated driving device recognizes the collision and changes a response related to an automated driving control. The traveling control device limits a motion of the vehicle according to the collision.

### BRIEF DESCRIPTION OF DRAWINGS

FIG. 1 is a configuration diagram showing an overview of a vehicle system.

FIG. 2 is a configuration diagram showing details of an automated driving ECU.

FIG. 3 is a configuration diagram showing details of an HCU.

FIG. 4 is a flowchart showing a processing method by the vehicle system.

FIG. 5 is a diagram showing an example of implementing both notifications.

FIG. 6 is a flowchart showing a processing method by the HCU.

FIG. 7 is a diagram showing an example of an auxiliary notification.

FIG. 8 is a flowchart showing a processing method by the HCU.

FIG. 9 is a flowchart showing a processing method by the vehicle system.

FIG. 10 is a block diagram showing an overall configuration of the vehicle system.

FIG. 11 is a flowchart showing a processing method by the HCU.

FIG. 12 is a diagram showing an example of a notification pattern.

FIG. 13 is a diagram showing an example of the notification pattern.

FIG. 14 is a diagram showing an example of the notification pattern.

FIG. 15 is a diagram showing an example of a notification.

FIG. 16 is a configuration diagram showing an overview of the vehicle system.

FIG. 17 is a flowchart showing a processing method by the HCU.

FIG. 18 is a configuration diagram showing an overview of the vehicle system.

FIG. 19 is a configuration diagram showing details of the HCU.

FIG. 20 is a flowchart showing a processing method by the vehicle system.

FIG. 21 is a flowchart illustrating a processing method by the vehicle system.

FIG. 22 is a configuration diagram showing details of a traveling control ECU.

FIG. 23 is a flowchart showing a processing method by the vehicle system.

FIG. 24 is a flowchart showing a processing method by the vehicle system.

### DETAILED DESCRIPTION

In an assumed situation, during automated driving without periphery monitoring obligation of the driver, the vehicle collides with a different object, and, as the result, the continuation of automated driving becomes impossible. In such a situation, when the driver is not monitoring the periphery, it can be difficult for the driver to immediately understand what has happened. Therefore, there is a concern that a smooth driving takeover may not be possible.

One aspect of the present disclosure provides a control device that enables a smooth driving takeover to the driver. Further, another aspect of the present disclosure provides an automated driving device and a travel control system suitable for this control device.

According to one aspect of the present disclosure, a control device is configured to control an in-vehicle device in a vehicle capable of traveling by automated driving without a periphery monitoring obligation of a driver, and the control device includes: an information grasping unit configured to determine collision occurrence information indicating presence or absence of a collision between the vehicle and a different object during the automated driving, and vehicle control information indicating control of the vehicle according to the collision; and a notification control unit configured to perform both of a notification indicating a control state of the vehicle and a notification prompting the driver to perform driving takeover.

According to such an embodiment, even when the driver is not monitoring the periphery, both notifications are executed. Therefore, the driver is possible to understand a state of vehicle control in response to the collision and what actions the driver needs to take. As a result, the driver is possible to start the operation of taking over driving with an understanding of the state of vehicle control. Therefore, it is possible to enable a smooth takeover of driving by the driver.

Also, another aspect of the present disclosure is an automated driving device configured to communicate with the control device described above and perform automated driving of the vehicle. The automated driving device includes: a collision recognition unit configured to recognize an occurrence of collisions between multiple different objects in a periphery of the vehicle; and a behavior determination unit configured to change a response related to a control of the automated driving depending on whether the vehicle is capable of leaving a collision site.

Also, another aspect of the present disclosure is a traveling control device configured to communicate with the control device described above and control the traveling of the vehicle. The traveling control device includes a motion limitation unit configured to limit motion of the vehicle in response to the collision after an occurrence of the collision.

In these aspects, it is possible to provide an automated driving device and a driving control device suitable for the control device described above.

Hereinafter, multiple embodiments will be described with reference to the drawings. It is noted that the same reference numerals are attached to the corresponding constituent elements in each embodiment, and redundant explanation may be omitted. In each of the embodiments, when only a part of the configuration is described, the remaining parts of the configuration may adopt corresponding parts of other embodiments. Further, not only the combinations of the configurations explicitly shown in the description of the respective embodiments, but also the configurations of the plurality of embodiments can be partially combined even when they are not explicitly shown as long as there is no difficulty in the combination in particular.

### First Embodiment

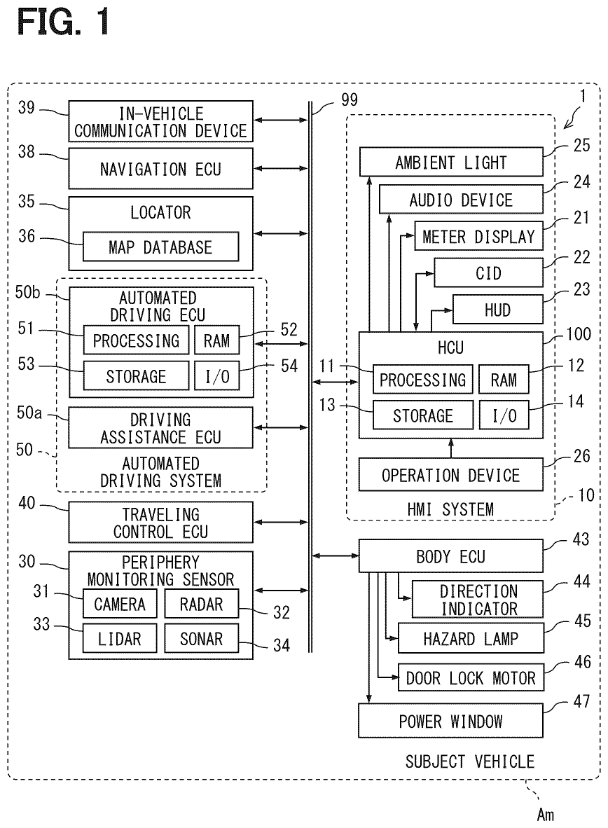

A vehicle system 1 can be used for a vehicle (hereinafter referred to as an automated driving vehicle) capable of automated driving. The automated driving may also be referred to as autonomous travel. As shown in FIG. 1, the vehicle system 1 includes a periphery monitoring sensor 30, a locator 35, a navigation ECU 38, an in-vehicle communication device 39, a traveling control ECU 40, a body ECU 43, a driving assistance ECU 50a, an automated driving ECU 50b, and an HCU (human machine interface control unit) 100. The periphery monitoring sensor 30, the locator 35, the navigation ECU 38, the in-vehicle communication device 39, the traveling control ECU 40, the body ECU 43, the driving assistance ECU 50a, the automated driving ECU 50b, and the HCU 100 are communicatively connected to a communication bus 99 of the in-vehicle network installed in the subject vehicle Am. These nodes connected to the communication bus 99 can communicate with each other. Specific nodes among these devices and ECUs may be directly electrically connected to each other by means such as a wire harness, and may be able to communicate without using the communication bus 99.

For stages (hereinafter referred to as automation levels) of automated driving in automated driving vehicles, there can be multiple levels, as defined, for example, by SAE (Society of Automotive Engineers). The automation levels are classified into levels 0 to 5, for example, as follows.

The level 0 is a level where the driver performs all driving tasks without any intervention of the system. The driving tasks may be reworded as dynamic driving tasks. The driving tasks are, for example, steering, acceleration and deceleration, and periphery monitoring. The level 0 corresponds to so-called fully manual driving. The level 1 is a level where the system assists a steering operation or an acceleration and deceleration operation. The level 1 corresponds to so-called driving assistance. The level 2 is a level where the system assists both the steering operation and the acceleration and deceleration operation. The level 2 corresponds to partial driving automation. For example, in the levels 1 and 2, the driver has the monitoring obligation for safe driving (hereafter simply referred to as monitoring obligation). In other words, the levels 1 and 2 can be classified as broad-sense manual driving. As part of the monitoring obligation, there is visual monitoring of the periphery.

The level 3 is a level where the system can perform all the driving tasks under a specific condition and the driver performs the driving operation in an emergency. In the automated driving at the level 3, it is required that the driver can quickly respond to a request of driving takeover from the system. The driving takeover can also be reworded as transfer of the periphery monitoring obligation from the vehicle system to the driver. The level 3 corresponds to a conditional driving autonomation. The level 3 includes an area limit level 3, which is limited to specific areas. The specific area described here may be an expressway. The specific area may be, for example, a specific lane. The level 3 also includes a traffic congestion limit level 3, which is limited to situations of traffic congestion. The automated driving at the traffic congestion limit level 3 corresponds to traffic congestion limit automated driving. The traffic congestion limit level 3 may be limited to traffic congestion in, for example, the expressway. The expressway may include the automobile road.

The level 4 is a level where the system is capable of performing all driving tasks, except under a specific circumstance, such as an unsupported road, an extreme environment, and the like. The level 4 corresponds to a highly automated driving operation. The level 5 of the automated driving is a level at which the system can perform all the driving tasks under all environments. The level 5 corresponds to a fully automated driving operation. The automated driving at levels 4 and 5 may be implemented, for example, in a traveling section where high-precision map data is prepared. The high-precision map data will be described later.

For example, the levels 3 to 5 may be classified as automated driving. The automated driving at levels 3 to 5 is an automated driving in which the driver does not have the monitoring obligation during automated driving at levels 3 to 5, a second task may be permitted. The second task is an action other than a driving operation permitted to the driver, and is a predetermined specific action. The second task can be rephrased as any task other than the driving task. The second task can also be reworded as a secondary activity, other activities, or the like. The second task must not prevent the driver from responding to a request (hereinafter, driving takeover request) to take over a driving operation from an automated driving system 50. The takeover may be also referred to as handover. As an example, viewing of a content such as a video, operation of a smartphone, reading, and eating are assumed as the second task.

Among the automated driving at the levels 3 to 5, the automated driving at the level 4 or higher level corresponds to the automated driving in which sleeping of the driver is permitted. In other words, the automated driving corresponds to sleep-permitted automated driving. The automated driving at the level 4 or higher can be referred to as automated driving that does not require a takeover to the driver even in an emergency. Among the levels 3 to 5, the automated driving at the level 3 corresponds to automated driving that does not permit the driver to sleep (hereinafter referred to as “non-sleep-permitted automated driving”). The automated driving vehicle of the present embodiment is capable of switching the automation level. A configuration may be employable in which the automation level is switchable within a part of the levels 0 to 5. The automated driving vehicle of the present embodiment is capable of switching between the automated driving without at least monitoring obligation and the manual driving.

The periphery monitoring sensor 30 is an autonomous sensor that monitors a peripheral environment of the subject vehicle Am. The periphery monitoring sensor 30 includes, for example, one or more of a camera unit 31, a millimeter-wave radar 32, a LIDAR 33, and a sonar 34. The periphery monitoring sensor 30 can detect a moving object and a stationary object from a detection range around the subject vehicle. The periphery monitoring sensor 30 provides detection information of objects in the periphery of the subject vehicle to the driving assistance ECU 50a and the automated driving ECU 50b, among others.

The locator 35 includes a GNSS (Global Navigation Satellite System) receiver and an inertial sensor, among other components. The locator 35 combines positioning signals received from multiple positioning satellites by the GNSS receiver, a measurement result of the inertial sensor, vehicle speed information output to the communication bus 99, and the like, and sequentially measures a subject vehicle position, a traveling direction, and the like of the subject vehicle Am. The locator 35 sequentially outputs, as locator information, the position information and the direction information of the subject vehicle Am based on a positioning result to the communication bus 99.

The locator 35 further has a map database (hereinafter referred to as map DB) 36 that stores map data. The map DB 36 mainly includes a large-capacity storage medium storing a large number of pieces of three-dimensional map data and two-dimensional map data. The three-dimensional map data is also known as high definition (HD) map, and includes road information necessary for the automated driving. Specifically, three-dimensional shape information of a road, detailed information of each lane, and the like are included in the three-dimensional map data. The locator 35 can update the three-dimensional map data and the two-dimensional map data to the latest information by external communication using the in-vehicle communication device 39. The locator 35 reads map data of the periphery of the current position from the map DB 36, and provides it to the driving assistance ECU 50a, the automated driving ECU 50b, and the like with locator information.

The navigation ECU 38 acquires information on a destination specified by an occupant including the driver, based on operation information acquired from the HCU 100. The navigation ECU 38 acquires the subject vehicle position information and the direction information from the locator 35 and sets a route from the current position to the destination. The navigation ECU 38 provides route information indicating the set route to the destination to the driving assistance ECU 50a, the automated driving ECU 50b, the HCU 100, and the like. The navigation ECU 38 cooperates with the HMI system 10 to notify the driver of the traveling direction of the subject vehicle Am at an intersection, a branch point, and the like by combining a screen display, an audio message, and the like as route guidance to the destination.

Here, a user terminal such as a smartphone may be connected to the in-vehicle network or the HCU 100. The user terminal may provide the subject vehicle position information, the direction information, the map data, and the like to the driving assistance ECU 50a, the automated driving ECU 50b, and the like in place of the locator 35. Further, the user terminal may provide the route information to the destination to the driving assistance ECU 50a, the automated driving ECU 50b, the HCU 100, and the like in place of the navigation ECU 38.

The in-vehicle communication device 39 is a vehicle exterior communication unit mounted on the subject vehicle Am and functions as a V2X (Vehicle to Everything) communication device. The in-vehicle communication device 39 transmits and receives information to and from a roadside device installed on the side of the road by wireless communication. In one example, the in-vehicle communication device 39 receives traffic congestion information of the periphery of the current position of the subject vehicle Am and in the traveling direction, road construction information, and the like from a roadside device. The traffic congestion information and the road construction information may be VICS (registered trademark) information or the like. The in-vehicle communication device 39 provides the received traffic congestion information and road construction information to the automated driving ECU 50b, and the HCU 100, and the like.

The traveling control ECU 40 is an electronic control unit primarily including a microcontroller. The traveling control ECU 40 has at least the functions of a brake control ECU, drive control ECU, and steering control ECU. The traveling control ECU 40 continuously performs brake force control for each wheel using a brake actuator 41, output control of the in-vehicle power source, and steering angle control based on one of operation instructions from the driver's driving operations, control instructions from the driving assistance ECU 50a, or control instructions from the automated driving ECU 50b.

The body ECU 43 is an electronic control unit primarily including a microcontroller. The body ECU 43 has at least the function of controlling the operation of lighting devices mounted on the subject vehicle Am (for example, turn indicator 44, hazard light 45, and the like). The body ECU 43 starts the flashing of either the left or right turn indicator 44 corresponding to the operation direction, based on the detection of user operations input to the turn signal switch (winker lever) mounted on the steering column or similar position.

Additionally, the body ECU 43 controls a door lock motor 46, which opens and closes the door lock mechanism of the subject vehicle Am. Additionally, the body ECU 43 controls a power window 47, which opens and closes the side windows of the subject vehicle Am.

The driving assistance ECU 50a and the automated driving ECU 50b constitute the automated driving system 50 of the subject vehicle Am. The driving assistance ECU 50a implements the driving assistance function that assists the driver's driving operations within the automated driving system 50. The driving assistance ECU 50a enables the driving assistance at the level 2 or the similar level or partial automation.

The automated driving ECU 50b is capable of taking over the driver's driving operations and can implement the automated driving at the level 3 or higher, where the system takes primary control. The automated driving performed by the automated driving ECU 50b is an automated driving without monitoring the periphery of the subject vehicle, in other words, an eyes-off automated driving without the periphery monitoring obligation of the driver.

In the automated driving system 50 described above, the traveling control state of the automated driving function is switched among multiple modes, which at least include driving assistance control with the periphery monitoring obligation by the driving assistance ECU 50a and automated driving control without the periphery monitoring obligation by the automated driving ECU 50b.

The driving assistance ECU 50a is a computer that primarily includes a control circuit equipped with a processing unit, RAM (Random Access Memory), a storage, input output interfaces, and a bus connecting these components. The driving assistance ECU 50a implements driving assistance functions such as ACC (Adaptive Cruise Control), LTC (Lane Trace Control), and LCA (Lane Change Assist) by executing programs in the processing unit. The ACC, LTC, and LCA are referred to as applications for driving assistance. The driving assistance ECU 50a provides the automated driving ECU 50b with control status information indicating the state of the driving assistance control.

The processing unit may include at least one processor. The processor includes, for example, at least one type of a central processing unit (CPU), a graphics processing unit (GPU), and a reduced instruction set computer (RISC)-CPU as a core. The storage may include at least one type of non-transitory tangible storage medium that non-temporarily stores programs and data readable by a processor 51b, such as semiconductor memory, magnetic media, and optical media.

The automated driving ECU 50b has a higher calculation capability than the driving assistance ECU 50a, and can perform at least traveling control corresponding to ACC and LTC. The automated driving ECU 50b may be capable of performing driver assistance control that requires the driver to monitor the periphery, in place of the driving assistance ECU 50a in situations where the control by the driving assistance ECU 50a is temporarily interrupted.

The automated driving ECU 50b is a computer that primarily includes a control circuit equipped with a processing unit 51, RAM 52, storage 53, input output interface 54, and a bus connecting these components. The processing unit 51 executes various processes to implement the automated driving control method of the present disclosure by accessing the RAM 52. The storage 53 stores various programs (such as automated driving control programs) that are executed by the processing unit 51.

The processing unit 51 may include at least one processor. The processor may include at least one type of core, such as a CPU (Central Processing Unit), GPU (Graphics Processing Unit), or RISC (Reduced Instruction Set Computer) CPU, among others. The storage 53 may include at least one type of non-transitory tangible storage medium, such as a semiconductor memory, magnetic medium, or optical medium, for non-temporarily storing programs and data readable by the processor.

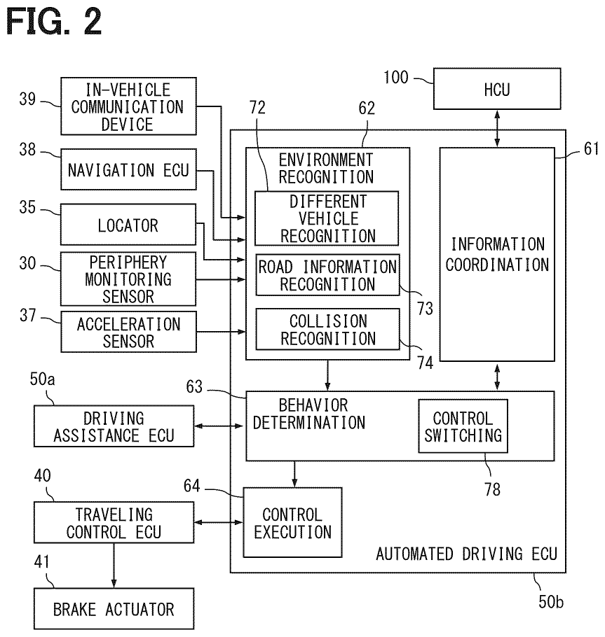

By executing the programs by the processing unit 51, the automated driving ECU 50b constructs multiple functional units to implement the automated driving function, such as an information coordination unit 61, an environment recognition unit 62, a behavior determination unit 63, and a control execution unit 64 (see FIG. 2).

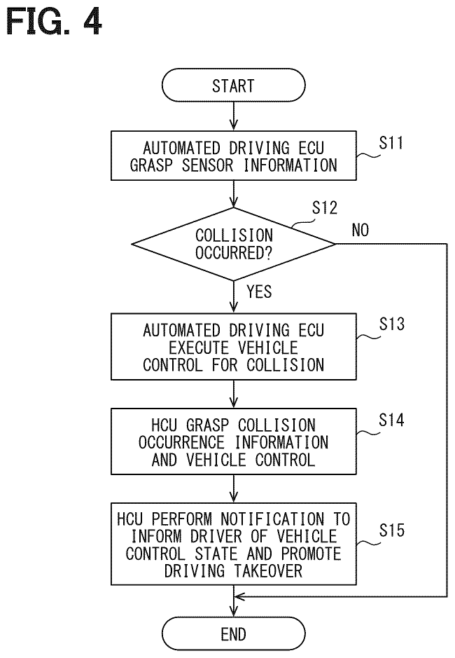

The information coordination unit 61 provides information to an information coordination unit 82 of the HCU 100 and acquires information from the information coordination unit 82 described later. By cooperation of these information coordination units 61 and 82, the automated driving ECU 50b and the HCU 100 share the information which each acquired. The information coordination unit 61 generates control status information indicating the operational state of the automated driving function and provides the generated control status information to the information coordination unit 82. The control status information includes collision occurrence information indicating that the subject vehicle Am has collided with the different object (also referred to as a collision object). The collision occurrence information is, for example, the determination result of the collision determination process (see S12 in FIG. 4) described later. Additionally, the control status information includes limit information of the automated driving function.

The information coordination unit 61 enables the HCU 100 to provide notifications synchronized with the operational state of the automated driving function by outputting control status information to the information coordination unit 82. Additionally, the information coordination unit 61 acquires operation information from the driver or other occupants from the information coordination unit 82 and grasps the content of user operations input into the HMI system 10 or other systems.

The environment recognition unit 62, as a sub-function unit for driving environment recognition, includes a different vehicle recognition unit 72 and a road information recognition unit 73. The different vehicle recognition unit 72 recognizes the relative positions and relative speeds of dynamic objects in the periphery of the subject vehicle Am, such as other vehicles traveling in the periphery. The different vehicle recognition unit 72 at least recognizes the forward and rearward vehicles traveling in the same lane (hereinafter referred to as ta subject vehicle lane) as the subject vehicle Am, as well as the side vehicles traveling in the adjacent lanes next to the subject vehicle lane. When the subject vehicle Am is traveling on a road with three or more lanes, the different vehicle recognition unit 72 recognizes the side vehicles traveling in the distant lane located on the opposite to the subject vehicle lane with respect to the adjacent lane.

The environment recognition unit 62, as sub-function units for travel environment recognition, includes the different vehicle recognition unit 72, the road information recognition unit 73, and a collision recognition unit 74. The different vehicle recognition unit 72 recognizes the relative positions and relative speeds of dynamic objects in the periphery of the subject vehicle Am, such as other vehicles traveling in the periphery. The different vehicle recognition unit 72 at least recognizes the forward and rearward vehicles traveling in the same lane (hereinafter referred to as ta subject vehicle lane) as the subject vehicle Am, as well as the side vehicles traveling in the adjacent lanes next to the subject vehicle lane. When the subject vehicle Am is traveling on a road with three or more lanes, the different vehicle recognition unit 72 recognizes the side vehicles traveling in the distant lanes located on the opposite to the subject vehicle lane with respect to the adjacent lane.

The road information recognition unit 73 recognizes information related to the road on which the subject vehicle Am is traveling. When the road information recognition unit 73 acquires route information from the navigation ECU 38, it extracts specific points on the road where the subject vehicle Am is scheduled to travel, specifically junctions on highways, merging points, and exit points. Furthermore, the road information recognition unit 73 identifies congested sections where traffic congestions are occurring and restricted sections where regulations are in place due to road construction or other factors on the roads that the subject vehicle Am is scheduled to travel.

The road information recognition unit 73 determines whether the road on which the subject vehicle Am is traveling or is scheduled to travel falls within a preset permission area or a limited permission area. The information indicating whether an area is the permission area or the limited permission area may be recorded in the map data stored in the map DB 36, or it may be included in the information received via the in-vehicle communication device 39. In more detail, the automated driving has multiple control modes. The control modes include a traffic congestion limit control (hereinafter referred to as traffic congestion level 3), which is limitedly executed for traveling in traffic congestion, and an area limit control (hereinafter referred to as area level 3), which is limitedly executed in a specific permission area. On roads within the permission area, both executions at both the traffic congestion level 3 and the area level 3 are permitted. On roads within the limited area, the execution of only the traffic congestion level 3 is permitted. On a road (hereinafter referred to as a non-permission area) that is not included in the permission area and the limited permission area, the automated driving is prohibited. The permission area and the limited permission area are set, for example, on expressways or motorways.

The collision recognition unit 74 recognizes the occurrence of a collision between the subject vehicle Am and a different object. Specifically, the collision recognition unit 74 recognizes a collision based on information such as images captured by the camera unit 31 and data from an acceleration sensor 37 (G-sensor) that detects the acceleration experienced by the subject vehicle Am. The collision recognition unit 74 may further recognize at least one of the type of the collision object, the collision part of the subject vehicle Am, and the extent of the collision. The collision recognition unit 74 provides the occurrence of the collision, the type of collision object, the impacted part, and the extent of the collision to the information coordination unit 61 as collision occurrence information.

The types of collision objects may include other vehicles, bicycles, pedestrians, buildings, utility poles, other structures, and objects fallen on the road. The collision recognition unit 74 may recognize the type of object collided with the vehicle based on images captured by the camera unit 31 and point cloud data obtained by the LiDAR 33.

The collision part may be the front portion, side portion, or rear portion of the vehicle body. The collision part may also be identified in more detail. The collision part may be specifically identified by components constituting the vehicle body, such as the front bumper, rear bumper, driver's door, right rear wheel area, and so on. The collision recognition unit 74 may recognize the collision part based on images captured by the camera unit 31, information from the acceleration sensor, and the malfunction status of periphery monitoring sensors 30 positioned at various parts of the vehicle.

The extent of the collision may be determined by the intensity of the collision at the time of collision. Alternatively, the extent of the collision may be determined by the degree of damage caused by the collision. The collision recognition unit 74 may determine the extent of damage from the collision based on images captured by the camera unit 31, the status of components such as the periphery monitoring sensors 30, and the degree of collision damage.

The behavior determination unit 63 coordinates with the driving assistance ECU 50a and the HCU 100 to control the driving takeover between the automated driving system 50 and the driver. When the driving operation control authority resides with the automated driving ECU 50b, the behavior determination unit 63 generates the scheduled travel line for the subject vehicle Am based on the recognition results of the travel environment from the environment recognition unit 62, and outputs the generated scheduled traveling line to the control execution unit 64.

When the control authority for driving operations resides with the automated driving ECU 50b, the control execution unit 64 coordinates with the traveling control ECU 40 to execute acceleration, deceleration, and steering control of the subject vehicle Am according to the scheduled traveling line generated by the behavior determination unit 63. Specifically, the control execution unit 64 generates control instructions based on the planned driving line and sequentially outputs these generated control instructions to the traveling control ECU 40.

As shown in FIG. 1, the HCU 100 is electrically connected to multiple display devices, an audio device 24, an ambient light 25, and an operation device 26. The HCU 100, multiple display devices, audio device 24, ambient light 25, and operation device 26 constitute the HMI system 10 of the subject vehicle Am.

The display devices provide information to the driver or other occupants visually through image display and other means. The display devices include a meter display 21, a center information display (hereinafter referred to as CID) 22, and a head-up display (hereinafter referred to as HUD) 23, among others. The CID 22 has a touch panel function and detects touch operations on the display screen by the driver or other occupants. In other words, the CID 22 also functions as the operation device 26.

The audio device 24 includes multiple speakers mounted within the vehicle cabin, arranged around the driver's seat, and it uses these speakers to play notification sounds or voice messages inside the cabin. The ambient light 25 is mounted on an instrument panel and a steering wheel, among other positions. The ambient light 25 provides notifications utilizing the driver's peripheral vision through ambient displays that change the emission color.

The operation device 26 is an input unit that accepts user operations from the driver or other occupants. The operation device 26 receives user operations such as those related to the activation and deactivation of the automated driving function, and the setting of destinations for route guidance. The operation device 26 includes a steering switch provided on a spoke part of the steering wheel, an operation lever provided on the steering column, and a voice input device that recognizes the speech of the driver or other occupants.

The HCU 100 is an information presentation device that integrally controls notifications using multiple display devices, the audio device 24, and the ambient light 25. The HCU 100, in coordination with the automated driving system 50, controls the notification of information related to automated driving. The HCU 100 is a computer that mainly includes a control circuit equipped with a processing unit 11, a RAM 12, a storage 13, an input output interface 14, and a bus connecting these components. The processing unit 11 executes various processes for notification control by accessing the RAM 12. The RAM 12 may be configured to include a video RAM for generating video data. The storage 13 stores various programs (such as notification control programs) that are executed by the processing unit 11.

The processing unit 11 may include at least one processor. The processor may include at least one type of core, such as a CPU (Central Processing Unit), GPU (Graphics Processing Unit), or RISC (Reduced Instruction Set Computer) CPU. The storage 13 may include at least one type of non-transitory tangible storage medium, such as a semiconductor memory, magnetic medium, or optical medium, for non-temporarily storing programs and data readable by the processor.

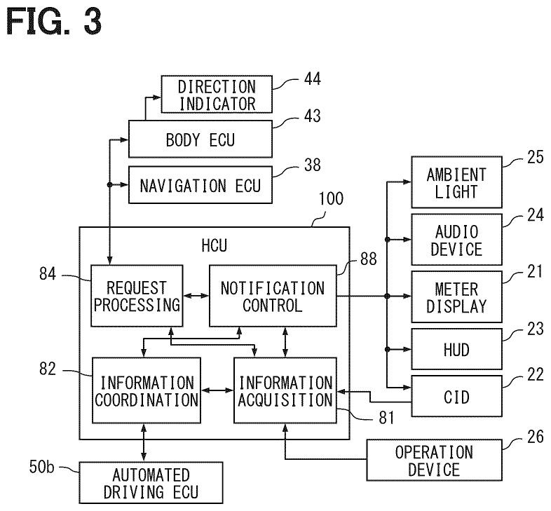

The HCU 100 constructs multiple functional units by the processing unit 11 executing the programs stored in the storage 13. The HCU 100 constructs functional units such as an information acquisition unit 81, an information coordination unit 82, a request processing unit 84, and a notification control unit 88 (see FIG. 3).

The information acquisition unit 81 acquires operation information indicating the content of user operations from the CID 22 and the operation device 26. The information acquisition unit 81 provides the operation information related to user operations concerning the automated driving function to the automated driving ECU 50b through the information coordination unit 82. The information acquisition unit 81 provides the operation information of user operations for setting the destination of the subject vehicle Am to the navigation ECU 38 through the request processing unit 84.

The information coordination unit 82 collaborates with the automated driving ECU 50b to enable the sharing of information between the automated driving system 50 and the HCU 100. The information coordination unit 82 provides the operation information, which is acquired by the information acquisition unit 81, to the automated driving ECU 50b. The information coordination unit 82 acquires control status information indicating the state of the automated driving function from the automated driving ECU 50b. The information coordination unit 82 monitors the operation state of automated driving by the automated driving system 50 based on the control status information. Specifically, the information coordination unit 82 determines whether the subject vehicle Am travels by the automated driving.

The request processing unit 84 enables coordination between the HCU 100 and various in-vehicle devices through communication with the in-vehicle devices connected to the communication bus 99. Specifically, the request processing unit 84 acquires route information to the destination, guidance images based on map data, and guidance execution requests from the navigation ECU 38 and provides them to the notification control unit 88. Thereby, it is possible to implement route guidance by the HMI (Human Machine Interface) system 10. Additionally, the request processing unit 84 enables the switching on and off the turn indicators 44 in coordination with displays related to automated driving by outputting operation requests to the body ECU 43.

The notification control unit 88 performs the integrative notification of information to the driver or other occupants using various display devices, the audio device 24, and ambient light 25. The notification control unit 88 processes the control status information acquired by the information coordination unit 82 as notification execution requests related to the automated driving function and provides contents and performs the notification in accordance with the operating state of the automated driving. The notification control unit 88 enables playback of video content or the like when execution of automated driving control in the eyes-off state is grasped by the information coordination unit 82. The notification control unit 88, upon grasping the scheduled end of automated driving, executes requests for driving takeover to the driver and the like.

Next, an example of the processing method by the vehicle system 1 will be described using the flowchart in FIG. 4. The series of processes shown in S11 to S15 is executed by at least one processor of the vehicle system 1 by executing a program, and executed at predetermined intervals or based on a predetermined trigger. It is preferable that this series of processes be executed during automated driving when the driver is not obligated to monitor the periphery. This series of processes is executed to ensure a smooth driving takeover to the driver immediately after a collision occurs.

In S11, the automated driving ECU 50b (for example, the environment recognition unit 62) acquires sensor information. The sensor information here may include at least one of the detection results from the periphery monitoring sensor 30, the detection results from the acceleration sensor 37 (G sensor), the position estimation results from the locator 35, or the information obtained via V2X communication. After the processing in S11, the flow proceeds to S12.

In S12, the automated driving ECU 50b (for example, the collision recognition unit 74) determines whether a collision has occurred between the subject vehicle Am and the different object. In a case of Yes (i.e., the occurrence of collision is recognized), the flow proceeds to S13. In a case of No (i.e., the occurrence of collision is not recognized), the series of processes ends with S12.

In S13, the automated driving ECU 50b (for example, the behavior determination unit 63) determines the response of the subject vehicle Am to the collision. Then, the automated driving ECU 50b (for example, the control execution unit 64) executes vehicle control according to the determined response to the collision. After the process in S13, the flow proceeds to S14.

In S14, the HCU 100 (for example, the information coordination unit 82) grasps the collision occurrence information, which includes information indicating the presence or absence of a collision, and the vehicle control information corresponding to the collision by acquiring this information from the automated driving ECU 50b. After the process in S14, the flow proceeds to S15.

In S15, the HCU 100 (for example, the notification control unit 88) performs both a notification indicating the state of the vehicle control corresponding to the collision and a notification prompting the driver to hand over driving. In other words, notifications indicating both the current state and what the driver should do are provided. It is preferable that the notification indicating the state of the vehicle control corresponding to the collision and the notification prompting the driver to take over driving be performed simultaneously. The series of processes ends with S15.

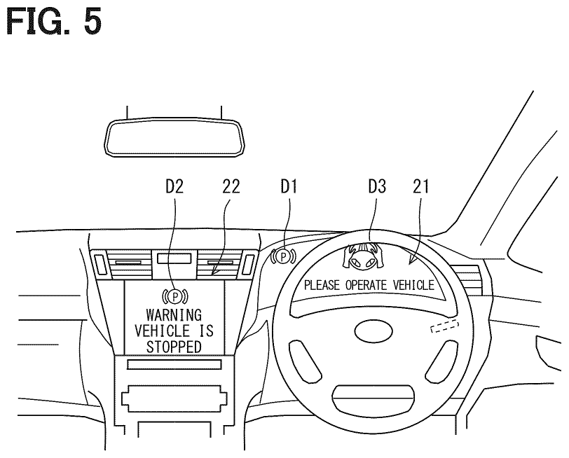

Here, as shown in FIG. 5, the notification in S15 will be described in detail. The notification indicating the state of vehicle control is, for example, a notification indicating that the movement of the subject vehicle Am is being restricted due to the operation of the brakes. Specifically, when the automated driving ECU 50b recognizes a collision between the subject vehicle Am and another object, it activates the brakes as a vehicle control response to the collision. The subject vehicle Am safely and promptly stop. The automated driving ECU 50b continues to maintain the activated state of the brakes even after stopping and restricts the movement of the subject vehicle Am until the driving is taken over to the driver. The activation of the brakes described here may refer to the operation of either the foot brake or the electric parking brake, or it may involve the operation of both. In the case of the foot brake, the restricted movement state of the subject vehicle Am may include not only a complete stop but also a creeping state.

The HCU 100 notifies the control state of the subject vehicle Am using devices such as a display device, audio device 24, and ambient light 25. The notification indicating the vehicle control state may be implemented, for example, by using multiple display devices in combination. For example, as shown in FIG. 5, the meter display 21 may indicate the activation of the electric parking brake using an indicator light or an indicator light-type image D1, while simultaneously the CID 22 may display a warning image D2 to indicate a state where the vehicle's movement is restricted.

Furthermore, when the automated driving ECU 50b or HCU 100 recognizes a collision between the subject vehicle Am and the different object, it may activate the hazard lights 45 of the subject vehicle Am as part of the vehicle control corresponding to the collision. The notification indicating the vehicle state may further include displaying the activation state of the hazard lights 45 on the meter display 21 using the indicator light or the indicator light-type image.

The notification prompting the driver to take over driving may change gradually according to the remaining time until the driver should complete the takeover. When the remaining time is greater than a predetermined threshold, for example, when there is still sufficient time before the driver needs to start the takeover operation, the notification prompting the driver to take over driving may indicate that the timing of the takeover to the driver is approaching. When the remaining time is less than a predetermined threshold, in the state where the driver should immediately start the handover operation, the notification prompting the driver to take over driving may indicate that the system is requesting the driving takeover of the driver. Furthermore, when the driver does not start the takeover operation at the required timing, the notification prompting the driver to take over driving may be a warning notification indicating that the driver should immediately take over the driving. Here, since the notification assumed in S15 is a sudden notification in response to a collision occurrence, the notification prompting the driver to take over driving may start as a notification indicating that the system is requesting the driving takeover to the driver or as a warning notification that the driver should immediately take over the driving.

The notification prompting the driver to take over driving may be implemented using at least one of the meter display 21 or the HUD 23, which are capable of being displayed in front of the driver. For example, as shown in FIG. 5, the notification prompting the driver to take over driving may include an image D3 on the meter display 21 showing the driver grasping the steering wheel. In this manner, the driver is possible to smoothly implement transition from confirming the notification to performing the takeover operation while facing forward. Alternatively, the notification prompting the driver to take over driving may be implemented using the CID 22. In this way, when the driver is watching a video using the CID 22 as a second task, the driver is possible to immediately recognize the need to take over driving.

According to the first embodiment described above, even in a situation where the driver is not monitoring the periphery, two notifications (a notification indicating the vehicle control state and a notification prompting the driver to take over driving) are both performed. Therefore, the driver is possible to grasp the state of control of the subject vehicle Am in response to a collision and what the driver should do. As a result, the driver is possible to start the operation of taking over driving with an understanding of the state of control of the subject vehicle Am. Therefore, it is possible to implement a smooth driving takeover to the driver.

Additionally, according to the first embodiment, the notification indicating the state of control of the subject vehicle Am includes a notification indicating that the movement of the subject vehicle Am is restricted due to the activation of the brakes, and a notification indicating that the hazard lights 45 of the subject vehicle Am are on. By understanding the specific control state in response to the collision, the driver is possible to calmly start the takeover operation.

It should be noted that the display device in the first embodiment corresponds to the “in-vehicle device”. At least one of the information acquisition unit 81 or the information coordination unit 82 in the first embodiment corresponds to an “information grasping unit”.

In addition, the grasping in the present embodiment may mean that the device that is the subject of the grasping acquires information from an external device, or that the device that is the subject of the grasping derives information by calculating or identifying it itself. In deriving the information, the source data required for analysis (such as sensor information and vehicle status) may be acquired from external devices.

### Second Embodiment

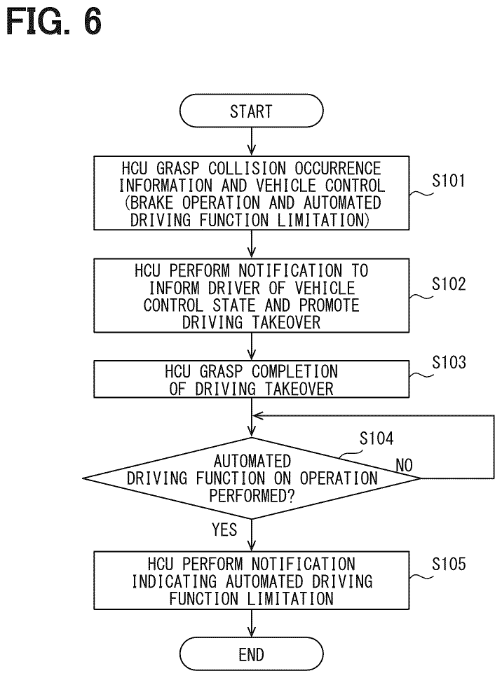

As shown in FIG. 6, a second embodiment is a modification of the first embodiment. The description of the second embodiment will focus on the differences from the first embodiment.

An example of the processing method by the HCU 100 in the second embodiment will be described using the flowchart in FIG. 6. The series of processes shown in S101 to S105 are executed by the processor of the HCU 100 executing a program. This series of processes is preferably executed during automated driving when the driver has no obligation to monitor the periphery. This series of processes may be implemented in correspondence with the processing of the automated driving ECU 50b in S11 to S13 of FIG. 4.

In S101, the HCU 100 (for example, the information coordination unit 82) acquires and understands collision occurrence information, which includes information indicating the presence or absence of a collision, and vehicle control information corresponding to the collision, from the automated driving ECU 50b. Here, the vehicle control corresponding to the collision includes not only the operation of the brakes as described in the first embodiment but also the restriction of automated driving functions.

The limitation of automated driving functions may include the prohibition of executing all functions of level 1 and above, including driving assistance and automated driving. The limitation of automated driving functions may include the prohibition of executing all functions of level 3 and above. The limitation of automated driving functions may include the prohibition of certain applications for driving assistance. A partial prohibition state refers to a condition where, for example, ACC can be executed but LTA cannot be executed. The limitation of automated driving functions may include a speed limit during automated driving. The HCU 100 identifies the specific conditions for such restrictions on automated driving functions.

After the process of S101, the flow proceeds to S102. S102 is similar to S15 in FIG. 4. The driving takeover from the system to the driver is executed by a notification prompting the driver to perform the takeover. After the process of S102, the flow proceeds to S103. In S103, the HCU 100 confirms the completion of the driving takeover. After the process of S103, the flow proceeds to S104.

In S104, the HCU 100 (for example, the information acquisition unit 81) determines whether the driver or another occupant has turned on the limited automated driving function using the operation device 26. This determination is executed by comparing the specific conditions recognized in S101 with the operation performed on the operation device 26. In a case of Yes, the flow proceeds to S105. In case of No, the determination in S104 is executed again until the limit on the automated driving function is released.

Additionally, when the function that has been turned on is not a prohibited function, the HCU requests the activation of that function through the information coordination unit 82 to the driving assistance ECU 50a or the automated driving ECU 50b.

In S105, the HCU 100 (for example, the notification control unit 88) issues a notification to the driver or other individuals who operated the operation device 26, the notification indicating that the automated driving function is limited. This notification is executed using the display device located closest to the operation device 26, or the specific meter display 21 or HUD 23, for a preset duration immediately after the operation. In this notification, the specific conditions described above may also be presented. The series of processes ends with S105.

Next, the release of limitations on the automated driving function will be described. The vehicle system 1 is configured such that the automated driving function, which is restricted in response to the occurrence of a collision, is prohibited from being released until specific predetermined conditions are satisfied. The specific conditions may include the passage of a predetermined amount of time set in advance after the collision. The specific conditions may include turning off an activation switch (for example, the ignition switch) of the subject vehicle Am.

Alternatively, the specific conditions may include the initialization of the vehicle system 1 or the automated driving ECU 50b. In the case where initialization is the condition, it essentially means that there will be no dedicated program within the vehicle system 1 to release the restriction. For example, the initialization process is executed by an authorized vehicle administrator when repairs to the vehicle body and vehicle diagnostics are performed, and it is determined that there are no issues with executing automated driving.

Here, the vehicle administrator may be, for example, a car dealer or a vehicle inspection agent, in cases where the subject vehicle Am is a personally owned vehicle (POV). In cases where the subject vehicle Am is a Mobility as a Service (MaaS) dedicated vehicle (also referred to as a service car), the vehicle administrator may be the operator of the vehicle service.

According to the second embodiment described above, when the information coordination unit 82 recognizes that the automated driving function of the subject vehicle Am is limited after a collision has occurred, the notification control unit 88 provides a notification indicating that the automated driving function is limited. By causing the driver to understand that the driver must manually operate the vehicle, it is possible to achieve smooth handling through manual driving.

Additionally, according to the second embodiment, the information acquisition unit 81 may recognize the operation to turn on the automated driving function for the operation device 26 of the subject vehicle Am. Then, in a case where it is recognized that the automated driving function of the subject vehicle Am is limited after the collision has occurred, when the operation to turn on the automated driving function is detected, the notification control unit 88 may provide a notification indicating that the automated driving function is limited. Such a notification is possible to prevent the driver from mistakenly thinking that the automated driving function has been turned on. Therefore, the driver is possible to appropriately perform the manual driving.

Additionally, according to the second embodiment, in the subject vehicle Am, the release of the limitation on the automated driving function may be prohibited until the initialization process is executed by the authorized vehicle administrator. Furthermore, in the subject vehicle Am, the release of the limitation on the automated driving function may be executed based on the vehicle activation switch being turned off. With such a setting, the limitation on the automated driving function is prevented from being released while issues such as malfunctions persist. Therefore, it is possible to reduce the issues such as secondary collisions or the like.

### Third Embodiment

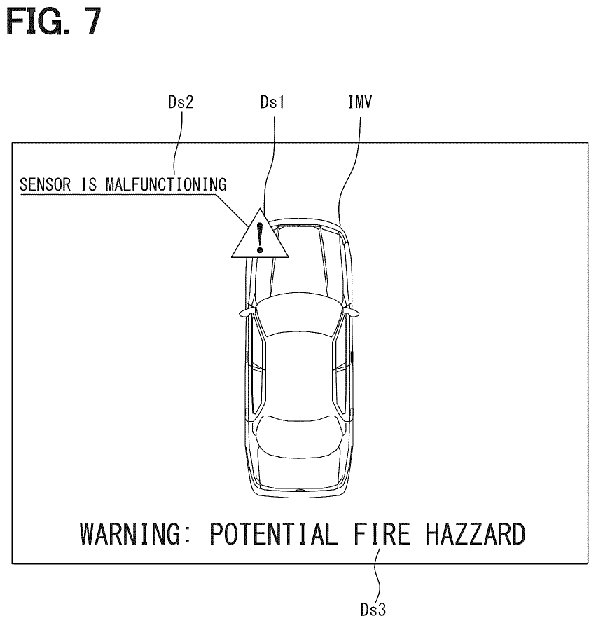

As shown in FIG. 7, a third embodiment is a modification of the first embodiment. The third embodiment will be described mainly focusing on the differences from the first embodiment.

In the third embodiment, the HCU 100 (for example, the notification control unit 88) executes at least one of notifications directed towards the driver or other occupants among a notification indicating the collision area, a notification indicating a malfunction, and a notification indicating the possibility of fire. These notifications are hereinafter referred to as auxiliary notifications. The auxiliary notifications are, for example, executed simultaneously with notifications indicating the state of vehicle control corresponding to the collision and notifications prompting the driver to take over driving.

The auxiliary notifications are displayed on screens such as the CID 22 and meter display 21, for example. As shown in FIG. 7, when the auxiliary notifications are executed in the form of a consolidated display content, the driver and others can easily recognize the information.

The notification indicating the collision part is, for example, executed in a manner where an icon Ds1 indicating the collision part is superimposed on a vehicle bird's-eye view image IMV that provides a bird's-eye view with respect to the subject vehicle Am. Through such visualization, the driver and others can instantly understand the collision part of the subject vehicle Am.

The notification indicating the malfunction is executed, for example, by text such as “sensor is malfunctioning” (Ds2). When this text Ds2 is associated with the collision part by a line or an arrow, the driver can instantly understand the relationship between the malfunction and the collision. Additionally, the notification indicating the malfunction may be executed by methods other than the text Ds2. For example, the notification indicating the malfunction can be achieved by changing the icon Ds1, which indicates the collision part, to an icon that indicates the malfunction, such as overlaying a slash on the image of the periphery monitoring sensor 30.

The notification indicating the possibility of a fire hazard is executed, for example, by a text Ds3 such as “warning: potential fire hazard”. This text Ds3 is arranged, for example, in the vicinity of the vehicle bird's-eye view image IMV in such a manner that it can be integrally recognized as an accompanying notification. Additionally, the notification indicating the potential fire hazard may be executed by methods other than text. For example, an icon indicating the potential hire hazard may be superimposed on the part of the subject vehicle Am in the vehicle bird's-eye view image IMV where the occurrence of the fire is anticipated.

The possibility of the fire hazard in the subject vehicle Am may be estimated by any one of the HCU 100, the driving assistance ECU 50a, or the automated driving ECU 50b. The possibility of the fire hazard is estimated based on the collision part, the degree of collision, and a malfunction status of components that malfunctioned due to the collision.

According to the third embodiment described above, the notification control unit 88 further performs a notification indicating the collision part of the subject vehicle Am. By understanding the collision part, the driver is possible to quickly grasp the periphery environment, including the collision part and other objects that came into contact with the collision part.

Additionally, according to the third embodiment, the notification control unit 88 further performs a notification indicating the malfunction associated with the collision part. Since the driver is possible to understand the malfunction occurrence status due to the impact of the collision, the driver is possible to promptly take actions such as manual driving in response to the malfunction occurrence.

Additionally, according to the third embodiment, the notification control unit 88 further performs a notification indicating the possibility of the fire hazard on the subject vehicle Am. By understanding the possibility of the fire hazard, the driver is possible to accurately determine whether it is necessary to evacuate the vehicle.

### Fourth Embodiment

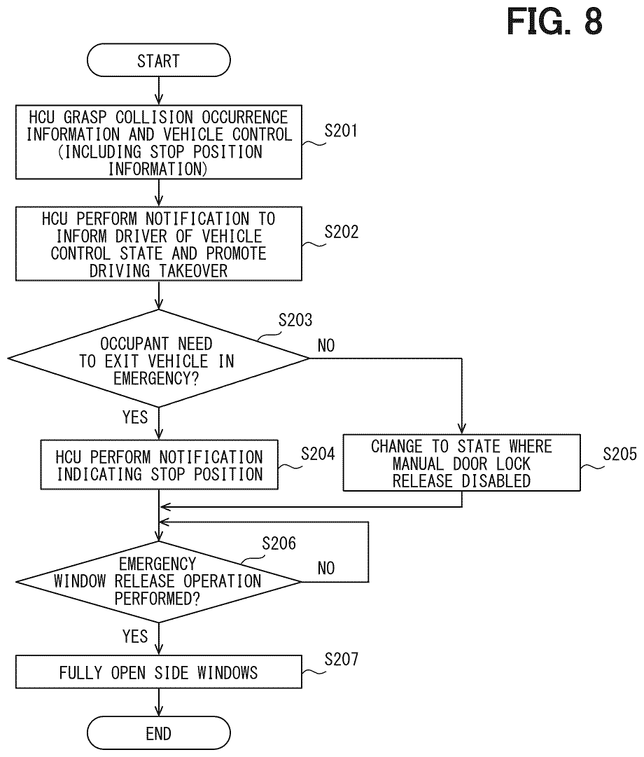

As shown in FIG. 8, a fourth embodiment is a modification of the first embodiment. The fourth embodiment will be described mainly focusing on the differences from the first embodiment.

An example of the processing method by the HCU 100 in the second embodiment will be described with reference to a flowchart in FIG. 8. The series of processes shown in S201 to S207 are executed by the processor of the HCU 100 executing a program. This series of processes is preferably executed during automated driving when the driver is not obligated to monitor the periphery. This series of processes may be implemented in correspondence with the processing of the automated driving ECU 50b in S11 to S13 of FIG. 4.

In S201, the HCU 100 (for example, the information coordination unit 82) acquires and grasps the collision occurrence information, which includes information indicating the presence or absence of a collision, and the vehicle control information corresponding to the collision, by acquiring this information from the automated driving ECU 50b. Here, the vehicle control corresponding to the collision includes the stop position in addition to the activation of the brakes as described in the first embodiment.

The stop position information indicates the position on the road where the subject vehicle Am has come to a stop as a result of the activation of the brakes. The stop position information may include information indicating which lane of a multi-lane road the subject vehicle Am has stopped in, for example, in the case of a road with multiple lanes on one side. After the processing of S201, the flow proceeds to S202.

S202 is same as S15 in FIG. 4. It is assumed that the driving takeover to the driver is executed by the system through a notification to the driver, in other words, the automated driving ends. After the processing of S202, the flow proceeds to S203.

In S203, the HCU 100 (for example, the notification control unit 88 or the request processing unit 84) determines whether the occupants, including the driver, need to urgently exit the vehicle. The HCU 100 may acquire the determination results from other ECUs. The necessity to exit the vehicle may be determined based on the possibility of the fire hazard or the occurrence situation of the fire hazard, as described in the third embodiment, for example. For example, in situations where there is a high possibility of the fire hazard in the subject vehicle Am, or where the fire hazard has already occurred, it is determined that there is a need to exit the vehicle. Additionally, the necessity to exit the vehicle may be determined by taking into account the external environment or weather conditions. For example, in situations where the outside terrain is unstable or fragile, or where there is a high possibility of an emotionally unstable person outside the vehicle due to an accident caused by aggressive driving, it may be determined that there is no need to exit the vehicle. In a case of Yes in S203, the flow proceeds to S204. In a case of No, the flow proceeds to S205.

In S204, the door lock is either automatically released or can be manually released by the driver or the like. The releasable state can be achieved by having the HCU 100 (for example, the request processing unit 84) request the body ECU 43, which controls the door lock motor 46, to enter the releasable state.

Furthermore, the HCU 100 (for example, the notification control unit 88) provides a notification indicating the stop position of the subject vehicle Am. The notification indicating the stop position of the subject vehicle Am may, for example, display which lane the subject vehicle Am is stopped in when on a multi-lane road. The HCU 100, for example, displays a bird's-eye view road image of an area in the periphery of the subject vehicle Am and an image of the subject vehicle Am superimposed on the bird's-eye view road image on the CID 22 or the meter display 21. Therefore, the driver and the like are possible to grasp the safe position based on the road structure. In other words, the driver or others can easily determine which of the left or right doors they should use to exit. After the processing in S204, the flow proceeds to S206.

In S205, the door locks are changed to a state where they cannot be released by manual operation of the driver or others. The unreleasable state can be achieved by having the HCU 100 request the body ECU 43, which controls the door lock motor 46, to set the unreleasable state. Thereby, it is possible to prevent the driver and the like, in a state of panic, from exiting from the vehicle when it would be better to remain inside. This unreleasable state may be changed to a releasable state after a preset time has elapsed. After the processing S205, the flow proceeds to S206.

In S206, the HCU 100 (for example, the information acquisition unit 81) determines whether the driver and the like have executed an emergency window opening operation using the operation device 26. It is preferable that the emergency window opening operation can be executed with a single action (such as a one-touch or one-push on a dedicated switch). In a case of Yes, the flow proceeds to S207. In a case of No, the HCU 100 (for example, the information acquisition unit 81) may wait until the emergency opening operation is detected. When the emergency opening operation is not detected within a preset time, the series of processes may end.

In S207, the side window is fully opened and controlled. When side windows are provided in the driver's seat, passenger seat, and rear seats, it is sufficient for all of these side windows to be opened. The side windows can be opened by the HCU 100 (for example, the request processing unit 84) requesting the body ECU 43, which controls the power windows 47, to perform an emergency opening. The series of processes ends with S207.

According to the fourth embodiment described above, the notification control unit 88 further performs a notification indicating the position on the road where the subject vehicle Am has stopped. Furthermore, the notification indicating the position on the road where the subject vehicle Am has stopped may include information about which lane the subject vehicle Am is stopped in on a multi-lane road. By allowing the occupant to understand the position of the subject vehicle Am on the road, it is possible to prevent situations where the occupant might carelessly open the door at a position likely to come into contact with other traveling vehicles or carelessly step out onto a road where traveling vehicles are present.

Additionally, according to the fourth embodiment, the request processing unit 84 requires the subject vehicle Am to set the door lock to a state where they cannot be manually unreleased by the occupants when there is no urgent need for the occupants to exit the subject vehicle Am. By setting the door locks to an unreleasable state, it is possible to prevent the occupant from inadvertently exiting the vehicle. Additionally, it is also possible to protect the occupant from external threats.

Further, according to the fourth embodiment, the information acquisition unit 81 detects the emergency window opening operation on the operation device 26 of the subject vehicle Am. The request processing unit 84, upon detecting the execution of an emergency opening operation, requires the subject vehicle Am to fully open its side windows. By fully opening the side windows, even when the abnormality occurs in the door opening and closing mechanism due to the impact of a collision and a fire hazard breaks out, the occupant will be able to evacuate from the vehicle.

### Fifth Embodiment

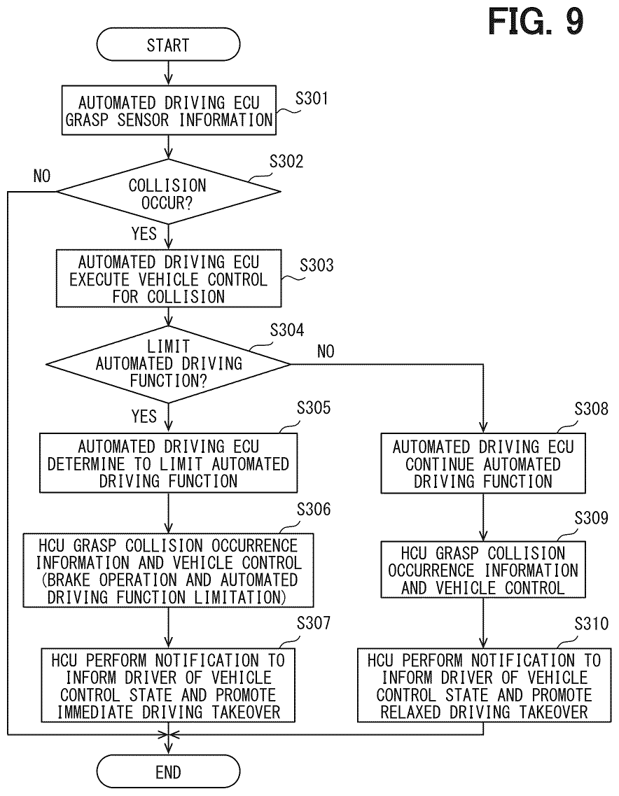

As shown in FIG. 9, a fifth embodiment is a modification of the first embodiment. The fifth embodiment will be described mainly focusing on configurations different from those of the first embodiment.

In the fifth embodiment, when a collision occurs between the subject vehicle Am and another object during automated driving, it is determined whether to continue the automated driving function based on predetermined conditions. Specifically, an example of the processing method by the vehicle system 1 in the fifth embodiment will be described with reference to the flowchart in FIG. 9. The series of processes shown in S301 to S310 are executed by at least one processor of the vehicle system 1 by executing a program at predetermined time intervals or based on a predetermined trigger. This series of processes is preferably executed during automated driving, where the driver has no periphery monitoring obligation. This series of processes is executed to ensure a smooth transition of driving control to the driver immediately after the occurrence of collision.

S301 to S303 are same as S11 to S13 in FIG. 4. After the processing in S303, the flow proceeds to S304.

In S304, the automated driving ECU 50b (for example, the behavior determination unit 63) determines whether to limit the automated driving function. This determination is made based on predetermined conditions that are based on the aspect of the collision.

The first example of the predetermined conditions is based on the degree of collision and the malfunction status of the sensor. When the degree of collision is smaller than a predetermined criterion and no malfunction of the periphery monitoring sensor 30 installed in the subject vehicle Am is confirmed, the automated driving ECU 50b (for example, the behavior determination unit 63) determines not to limit the automated driving function. The case where no malfunction is confirmed may be a case where a normal state is confirmed. On the other hand, when the degree of collision is greater than a predetermined criterion, or when the malfunction of the periphery monitoring sensor 30 installed in the subject vehicle Am is confirmed at even one position, the automated driving ECU 50b (for example, the behavior determination unit 63) determines to limit the automated driving function.

A second example of the set condition is a condition based on the collision part and the collision object. This condition may take into account at least one of the size and type of the collision object. When the collision part of the subject vehicle Am is a part that does not affect the execution of automated driving (for example, a minor collision such as only scraping the wheel cover), the automated driving ECU 50b (for example, the behavior determination unit 63) determines not to limit the automated driving function. Additionally, when the size of the collision object is smaller than a predetermined criterion (for example, small debris or pebbles), the automated driving ECU 50b (for example, the behavior determination unit 63) determines not to limit the automated driving function. When the size is not smaller, the automated driving ECU 50b (for example, the behavior determination unit 63) determines to limit the automated driving function. In a case of Yes in S304, the flow proceeds to S305. In a case of No, the flow proceeds to S308.

In S305, the automated driving ECU 50b (for example, the behavior determination unit 63) determines to limit the automated driving function. After the processing S305, the flow proceeds to S306.

In S306, the HCU 100 (for example, the information coordination unit 82) grasps the collision occurrence information and vehicle control. Specifically, the brake operation information and the limit information of the automated driving function are grasped. After the processing in S306, the flow proceeds to S307.

In S307, the HCU 100 (for example, the notification control unit 88) executes both the notification indicating the state of vehicle control in response to the collision and the notification prompting the driver to take over driving. In other words, notifications indicating both the current state and what the driver should do are provided. The notification indicating the vehicle control state in response to the collision and the notification prompting the driver to take over driving may be executed simultaneously. Here, in particular, the notification prompting the driver to take over driving is a warning that the driver should immediately take over driving. The series of processes ends with S307.

In S308, in a case of No in S304, the automated driving ECU 50b (for example, the behavior determination unit 63) determines to continue the operation without limiting the automated driving function. At this time, the automated driving ECU 50b (for example, the behavior determination unit 63) may determine to continue traveling without causing the subject vehicle Am to completely stop, depending on the degree of the collision and the collision object. After the process in S308, the flow proceeds to S309.

In S309, the HCU 100 (for example, the information coordination unit 82) grasps information on the collision occurrence and vehicle control. Specifically, brake operation information and automated driving function limitation information are grasped. After the process in S309, the flow proceeds to S310.

In S310, the HCU 100 (for example, the notification control unit 88) performs both a notification indicating the state of vehicle control in response to the collision and a notification prompting the driver to take over driving. In other words, notifications indicating both the current state and what the driver should do are provided. The notification indicating the state of vehicle control in response to the collision and the notification prompting the driver to take over driving may be executed simultaneously. Here, in particular, the notification prompting the driver to take over driving is a notification that prompts the driver to perform a non-urgent (in other words, relaxed) takeover of driving. In other words, the notification prompting a relaxed takeover of driving by the driver may be a non-urgent notification indicating that the driver can take over driving when they are ready. Alternatively, the notification prompting a relaxed takeover of driving by the driver may be a non-urgent notification indicating that the timing for the driver to take over driving is approaching, as described in the first embodiment. The series of processes ends with S310.

According to the fifth embodiment described above, the notification control unit 88 executes the process based on the determination to continue the automated driving function, which is made according to predefined conditions based on the aspect of the collision. This process is a notification prompting a takeover of driving by the driver, and is less urgent compared to the notification when the automated driving function is limited. With the less urgent and more relaxed notification, the driver is possible to calmly take over driving even in the event of a collision.

Additionally, according to the fifth embodiment, the predefined conditions based on the aspect of the collision may be conditions based on the extent of the collision and the malfunction status of the periphery monitoring sensor 30 installed in the subject vehicle Am. By adopting such conditions, it is possible to determine whether to continue the automated driving function while considering the proper operational feasibility of the automated driving function.

Additionally, according to the fifth embodiment, the preset conditions based on the aspect of the collision may be conditions based on the collision part of the subject vehicle Am and other objects. By adopting such conditions, it is possible to determine whether to continue the automated driving function while considering the necessity of responding to the collision.

### Sixth Embodiment

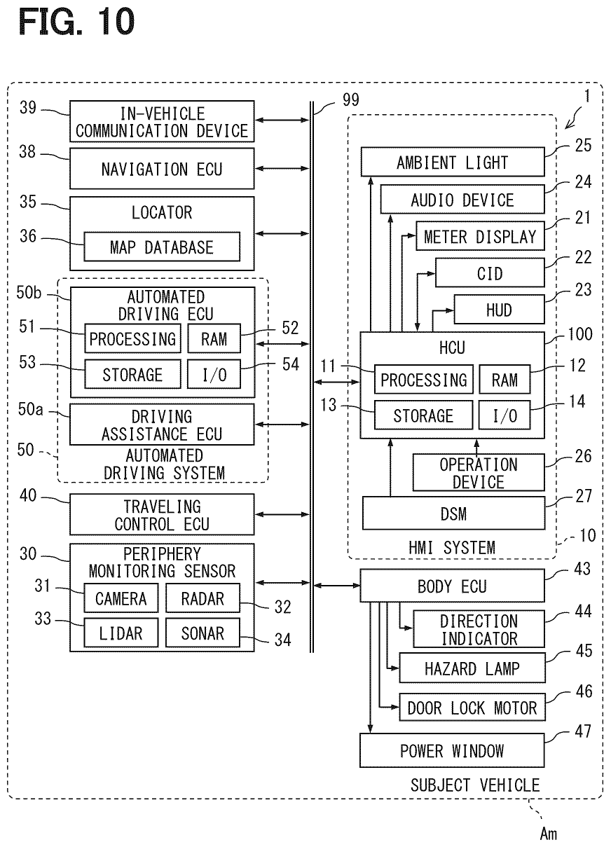

As shown in FIGS. 10 to 14, a sixth embodiment is a modification of the first embodiment. The sixth embodiment will be described mainly focusing on configurations different from those of the first embodiment.

In the sixth embodiment, the HCU 100 (for example, the notification control unit 88) changes the amount of information in the notification shown in S15 of FIG. 4 according to the condition of the occupant (for example, the driver) at the time of the collision. The HCU 100 (for example, the information acquisition unit 81) determines the driver's state at the time of collision by acquiring occupant state information from occupant state sensors such as a Driver Status Monitor (DSM) 27.

As shown in FIG. 10, the DSM 27 is provided in the HMI system 10 of the vehicle system 1, for example. The DSM 27 includes, for example, a configuration consisting of a near-infrared light source, a near-infrared camera, and a control unit for controlling these components. The DSM 27 is positioned on the instrument panel, with the near-infrared camera oriented towards the driver's seat. The DSM 27 captures images of the driver illuminated by near-infrared light from the near-infrared light source using the near-infrared camera. The images captured by the near-infrared camera are analyzed by the control unit. Based on the features extracted from the image analysis, the control unit detects the driver's level of alertness, facial orientation, and any posture deviations.

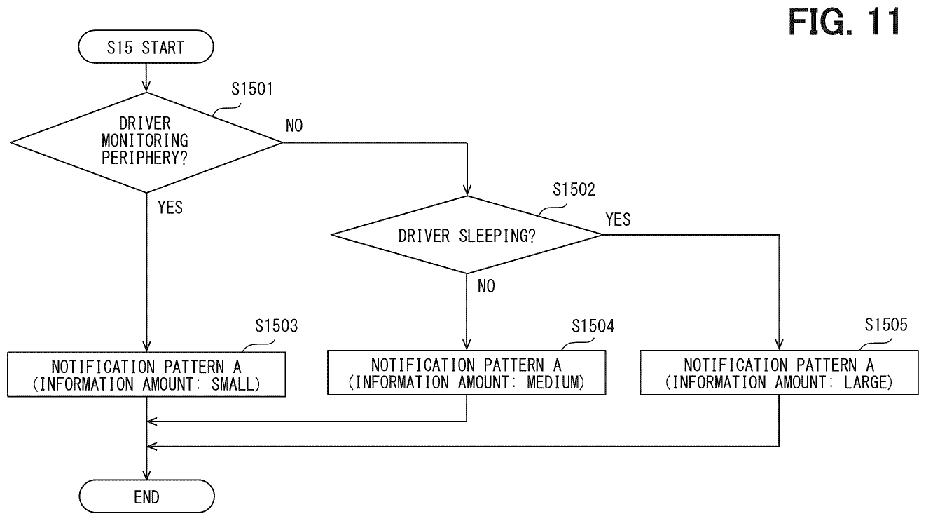

An example of the processing method by the vehicle system 1 of the sixth embodiment will be described using the flowchart in FIG. 11. A series of processes shown in steps S1501 to S1505 shows a detailed example of the process of S15 in FIG. 4.

In S1501, the HCU 100 (for example, the notification control unit 88) determines whether the driver is in the periphery monitoring state. In a case of Yes, the flow proceeds to S1503. In a case of No, the flow proceeds to S1502.

In S1502, the HCU 100 (for example, the notification control unit 88) determines whether the driver is in a state of sleep. In a case of Yes, the flow proceeds to S1505. In a case of No, the flow proceeds to S1503.

In S1503, when it is determined that the driver is monitoring the periphery, the HCU 100 (for example, the notification control unit 88) selects notification pattern A, which has a small amount of information, as the notification pattern for the CID 22, and causes the CID 22 to provide the notification.

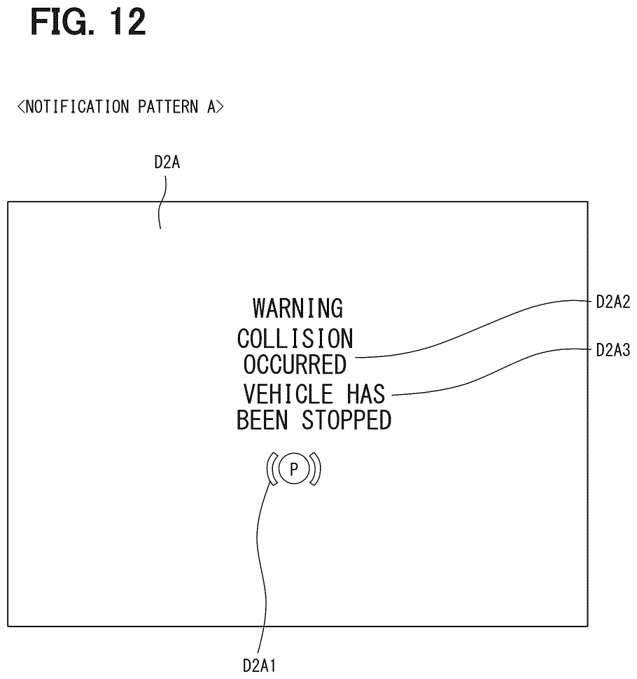

The notification pattern A may include a warning image D2A, which serves as a notification indicating the state of vehicle control in response to a collision, as shown in FIG. 12. The warning image D2A may include notifications indicating the activation of the electric parking brake, the occurrence of a collision, and the state in which the movement of the vehicle is restricted. The notification indicating the activation of the electric parking brake may be, for example, an image D2A1 in the form of a display light. The notification indicating the occurrence of a collision may be a simple image displaying only the fact that a collision has occurred, such as an image D2A2 primarily including text. The notification indicating the state in which the movement of the vehicle is restricted may be, for example, an image D2B3 primarily including text. The series of processes ends with the process of S1503.

When it is determined that the driver is neither monitoring the periphery nor sleeping, in other words, when the driver is engaged in a secondary task as determined in S1504, the HCU 100 (for example, the notification control unit 88) selects notification pattern B, which has a medium level of information, as the notification pattern for CID 22 and causes the CID 22 to provide the notification. The information amount of notification pattern B is set to be greater than that of notification pattern A.

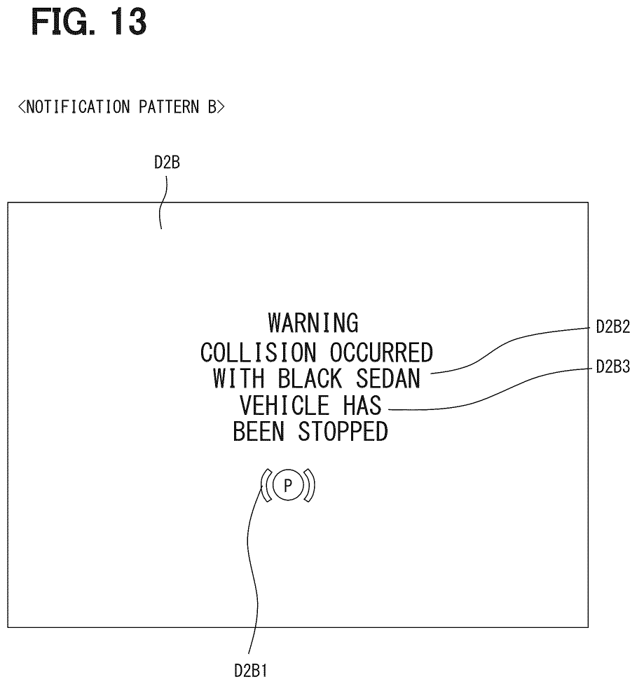

The notification pattern B may include a warning image D2B, which serves as a notification indicating the state of vehicle control in response to a collision, as shown in FIG. 13. The warning image D2B may include notifications indicating the activation of the electric parking brake, the occurrence of a collision, and the state where the movement of the vehicle is restricted. The notification indicating the activation of the electric parking brake (for example, image D2B1) and the notification indicating the state where the movement of the vehicle is restricted (for example, image D2B3) may be the same as those in the notification pattern A. The notification indicating the occurrence of a collision may be an image D2B2 that displays not only the state that the collision has occurred but also the type of object that was collided with. When the collision object is a vehicle, the type of object may include the classification of the vehicle (such as passenger car, truck, bus, and the like) and may also include characteristics of the vehicle (such as color, size, brand, model, license plate number, and the like). The series of processes ends with the process of S1504.

In S1505, when it is determined that the driver is sleeping, the HCU 100 (for example, the notification control unit 88) selects notification pattern C, which has a high amount of information, as the notification pattern for the CID 22, and causes the CID 22 to provide the notification. The information amount of notification pattern C is set to be greater than that of notification pattern A, and also greater than that of notification pattern B.

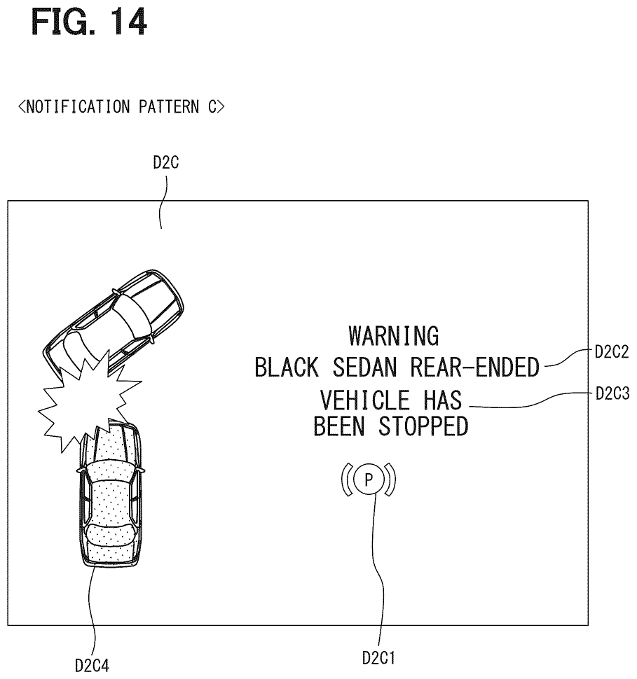

As shown in FIG. 14, the notification pattern C may include a warning image D2C as a notification indicating the state of vehicle control in response to the collision. The warning image D2C may include notifications indicating the activation of the electric parking brake, the occurrence of a collision, and the state in which vehicle movement is restricted. The notification indicating the activation of the electric parking brake (for example, image D2C1) and the notification indicating the state in which vehicle movement is restricted (for example, image D2C3) may be the same as those in the notification pattern A.

The notification indicating the occurrence of a collision in notification pattern C may, for example, combine a text-based image D2C2 and a graphic-based image D2C4 to indicate the state where the collision has occurred, the type of collision object, and the positional relationship between the subject vehicle Am and the collision object. The image D2C2 may display, in addition to the state that a collision has occurred, the type of collision object and a direction of the collision. The image D2C4 may illustrate the positional relationship between the subject vehicle Am and the collision object from a bird's-eye view. The series of processes ends with S1505.

In S1503 to S1505, the meter display 21 should execute a notification prompting the driver change, similar to that shown in FIG. 5.

According to the sixth embodiment described above, the notification is executed in such a way that the amount of information is adjusted based on the state of the occupant at the time of the collision. Therefore, it is possible to smoothly execute the driving takeover while reducing the annoyance felt by the occupant.

According to the sixth embodiment, when the occupant is in the sleeping state, the notification is performed so as to provide a larger amount of information than when the occupant is in the second task state. When the occupant is performing the second task, the notification is made so as to provide a larger amount of information than when the occupant is monitoring the periphery. By adjusting the amount of information according to the state of sleep or secondary tasks, it is possible to further reduce the annoyance felt by the occupant and provide the necessary information.

Additionally, according to the sixth embodiment, when the occupant is in a state other than monitoring the periphery, a notification indicating the type of other objects is executed. When the occupant is not monitoring the periphery, it takes time to identify the other object involved in the collision. On the other hand, by notifying the type of the object, it is possible to shorten the time required for the occupant to understand and recognize the other object involved in the collision. Therefore, it is possible to smoothly perform the driving takeover.

### Seventh Embodiment

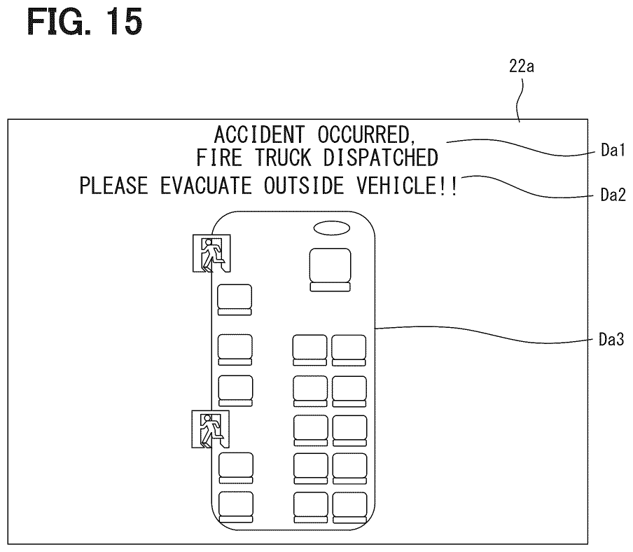

As shown in FIG. 15, a seventh embodiment is a modification of the fourth embodiment. The seventh embodiment will be described mainly focusing on configurations different from those of the fourth embodiment.

In the seventh embodiment, in S204 of the fourth embodiment, the HCU 100, in addition to or instead of providing a notification indicating the stop position, performs at least one of a notification indicating guidance for accident handling and a notification indicating the actions required of the vehicle occupants.

In FIG. 15, an example is shown where the subject vehicle Am is a bus, and notifications are provided using an in-vehicle display 22a for passengers. The in-vehicle display 22a is controlled by the HCU 100 in the same manner as the CID 22 in the bus. The notifications indicating guidance for accident handling may include, for example, notifications (image Da1) showing the deployment status of vehicles for accident handling, and notifications (image Da3) guiding occupants to bus's emergency exits). The notifications indicating the actions required of the occupant may include, for example, notifications guiding the occupant to evacuate the vehicle (image Da3).

According to the seventh embodiment described above, after a collision, notifications indicating guidance for accident handling are provided. As a result, the occupants can decide their subsequent actions based on an understanding of the accident handling situation.

Additionally, according to the seventh embodiment, after a collision, notifications indicating the actions required of the vehicle occupants are provided. Therefore, the occupant is possible to take more appropriate actions by following the notifications.

### Eighth Embodiment

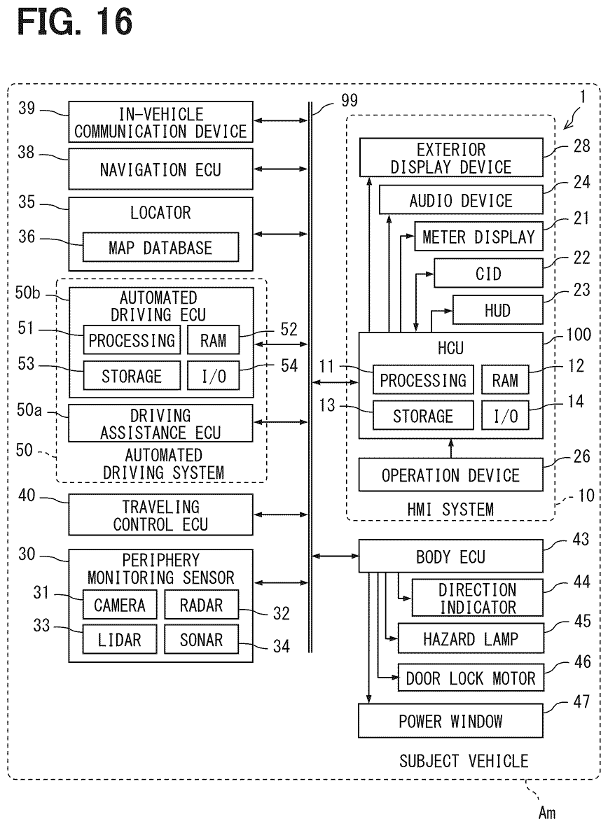

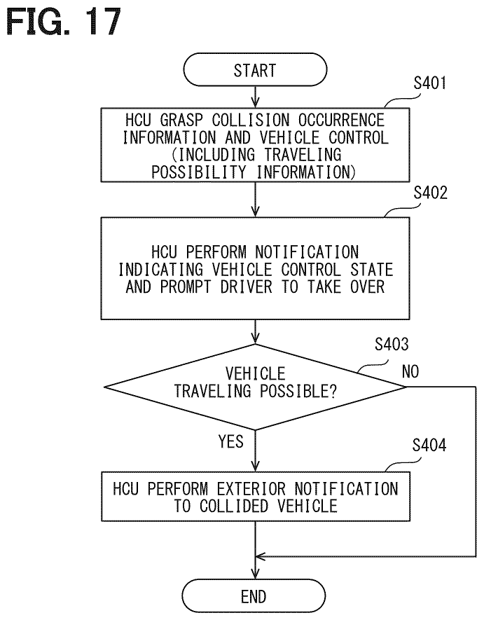

As shown in FIG. 16 and FIG. 17, an eighth embodiment is a modification of the first embodiment. The eighth embodiment will be described mainly focusing on configurations different from those of the first embodiment.

In FIG. 16, an HMI system 10 is shown for the case where the subject vehicle Am is a bus. The HMI system 10 includes an exterior display device 28 instead of the ambient light 25.

The exterior display device 28 is provided on the exterior part of the vehicle body and is configured as a display, such as a liquid crystal panel or OLED, capable of displaying images. The exterior display device 28 may be provided as a single unit, but multiple devices may also be provided, such as a device for displaying towards the front of the vehicle and a device for displaying towards the rear of the vehicle. When the HCU 100 has not detected collision occurrence information, the exterior display device 28 may display the destination or indicate that occupants are boarding or alighting.

An example of the processing method by the vehicle system 1 of the eighth embodiment will be described with reference to a flowchart in FIG. 17. The series of processes shown in S401 to S404 are executed by at least one processor of the vehicle system 1 executing a program. This series of processes is preferably executed during automated driving when the driver is not required to monitor the periphery. This series of processes should be executed in correspondence with the processing of the automated driving ECU 50b in S11 to S13 of FIG. 4.

In S401, the HCU 100 (for example, the information coordination unit 82) acquires and understands the collision occurrence information, which includes information indicating the presence or absence of a collision, and the vehicle control information corresponding to the collision by acquiring the information from the automated driving ECU 50b. Here, the vehicle control corresponding to the collision includes not only the operation of the brakes described in the first embodiment, but also information indicating whether the subject vehicle Am is capable of driving, referred to as traveling possible information. After the processing in S401, the flow proceeds to S402.

S402 is the same as S15 in FIG. 4. It is assumed that the driving takeover to the driver is executed by the system through a notification to the driver, meaning that the automated driving will end. After the processing in S402, the flow proceeds to S403.

In S403, the HCU 100 (for example, the notification control unit 88) determines whether the subject vehicle Am is capable of traveling. In a case of Yes, the flow proceeds to S404. In a case of No, the series of processes ends.

In S404, the HCU 100 (for example, the notification control unit 88) performs an exterior notification to the different object when the collision object is a dynamic object that can recognize the exterior notification, such as another vehicle. The different object may be a motorcycle, bicycle, or pedestrian. The exterior notification may be executed by the display of the exterior display device 28. The exterior notification may be performed by the external speaker sound, or a combination of the display and the speaker sound may be used. The exterior notification may be a notification to safely guide the different object for the purpose of allowing the subject vehicle Am to resume traveling. The notification to safely guide the other object may be, for example, a notification indicating a safe stop position for the other object. The series of processes ends with the process of S404.

As described above in the eighth embodiment, after a collision, when the subject vehicle Am is capable of traveling, the exterior notification to guide other dynamic objects is executed to allow the subject vehicle Am to resume traveling. External road users who have confirmed the exterior notification can take action with the understanding that the subject vehicle Am may resume traveling.

### Ninth Embodiment

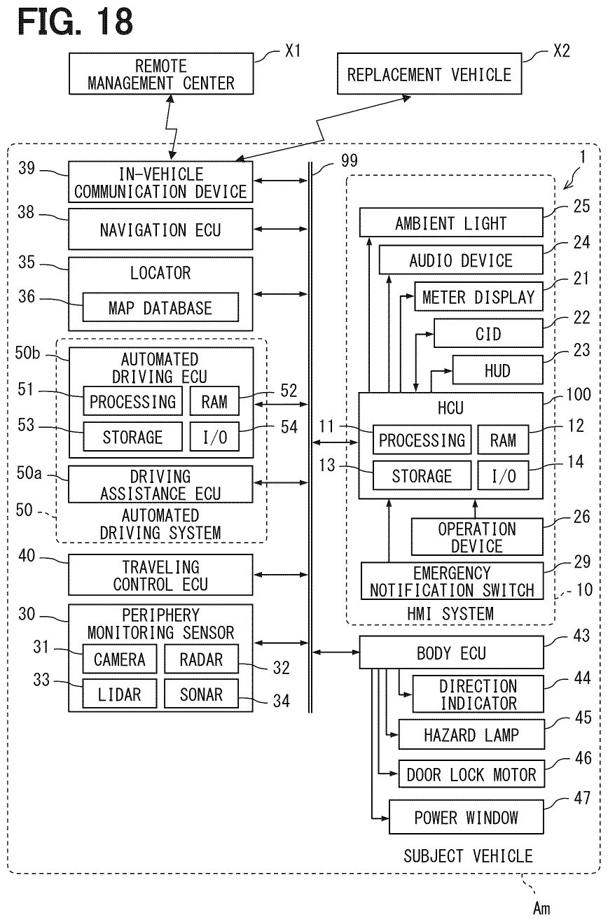

As shown in FIGS. 18 to 20, a ninth embodiment is a modification of the first embodiment. The ninth embodiment will be described mainly focusing on configurations different from those of the first embodiment.

The HMI system 10 shown in FIG. 18 includes an emergency notification switch 29. The emergency notification switch 29 is located, for example, at a position within the driver's reach on the ceiling of the vehicle interior or on the instrument panel. The emergency notification switch 29 may be, for example, a push button labeled “SOS”.

Additionally, the in-vehicle communication device 39 is capable of communicating with a remote management center X1 and a replacement vehicle X2. The remote management center X1 is a center that remotely manages or supports each vehicle traveling on public roads and the like. The remote management center X1 includes a configuration that includes computers capable of communicating with each vehicle. The remote management center X1 may have operators stationed to operate the computers. The replacement vehicle X2 is, for example, a vehicle arranged by an operator at the remote management center X1.

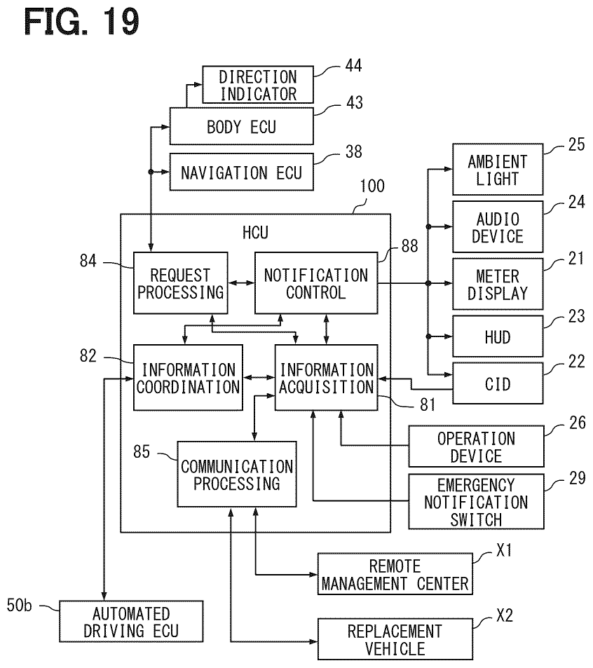

As shown in FIG. 19, the information acquisition unit 81 of the HCU 100 acquires an operation signal indicating that the emergency notification switch 29 has been operated by the occupant of the subject vehicle Am in the event of a collision or similar incident. The HCU 100 further includes a communication processing unit 85.

When the information acquisition unit acquires the operation signal, the communication processing unit 85 initiates communication with the remote management center X1 through the in-vehicle communication device 39. The remote management center X1 or its operator grasps the occurrence status of the collision through a conversation with the HCU 100 or the occupant using the HCU 100. When determining that the subject vehicle Am is unable to continue traveling, the remote management center X1 or its operator arranges for the replacement vehicle X2 for the transfer by the occupant of the subject vehicle Am.

The replacement vehicle X2 may be selected from available vehicles in the periphery of the collision site. The available vehicle may be one that has been pre-registered as the replacement vehicle X2. The available vehicle may be one used as the remote the replacement vehicle X2 when the management center X1 or its operator request proceeding to the collision site and the request is accepted.

When the arranged replacement vehicle X2 arrives at the scene, the notification control unit 88 issues a notification indicating the arrival of the replacement vehicle X2 and a notification indicating the position of the replacement vehicle X2. This notification may be executed, for example, by displaying a map image indicating the position of the replacement vehicle X2 on the CID 22.

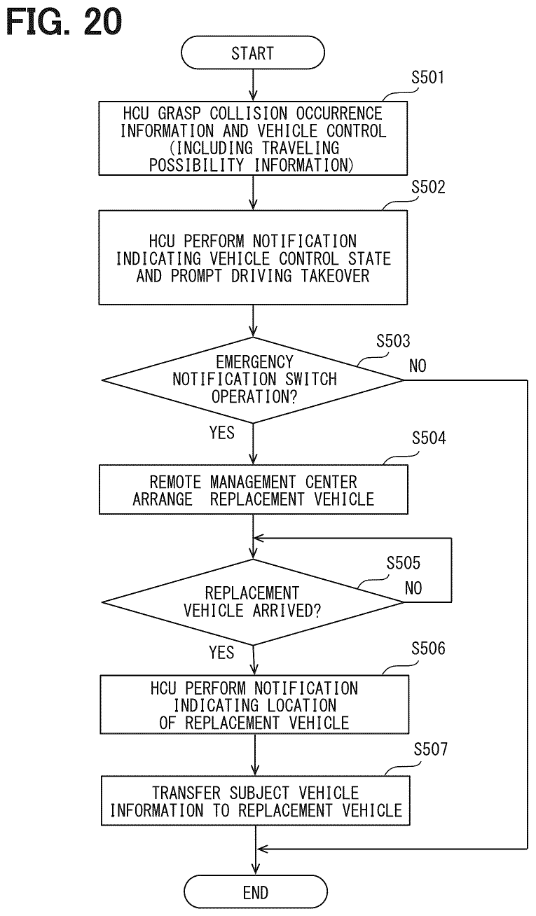

An example of the processing method by the vehicle system 1 of the ninth embodiment will be described with reference to a flowchart in FIG. 20. The series of processes shown in S501 to S507 are executed by at least one processor of the vehicle system 1 executing a program. This series of processes is preferably executed during automated driving when the driver is not required to monitor the periphery. This series of processes should be executed corresponding to the processes of the automated driving ECU 50b in S11 to S13 of FIGS. 4.

S501 and S502 are same as S401 and S402 in the eighth embodiment. After processing in S502, the flow proceeds to S503.

In S503, the HCU 100 (for example, the information acquisition unit 81) determines whether the occupant of the subject vehicle Am has operated the emergency notification switch 29. In a case of Yes, the flow proceeds to S504. In a case of No, the series of processes ends.

In S504, the HCU 100 (for example, the communication processing unit 85) performs an emergency notification to the remote management center X1. The remote management center X1 arranges the replacement vehicle X2 and notifies the HCU 100 that the arrangement has been made. After processing in S504, the flow proceeds to S505.

In S505, the HCU 100 (for example, the notification control unit 88) determines whether the replacement vehicle X2 has arrived in the periphery of the site. The determination of arrival may be based on a notification from at least one of the remote management center X1 and the replacement vehicle X2. The determination of arrival may also be based on the periphery monitoring sensor 30 recognizing the replacement vehicle X2 in the periphery of the subject vehicle Am. In a case of Yes, the flow proceeds to S506. In a case of No, after the passage of a predetermined time, the determination of S505 is performed again.

In S506, the HCU 100 (for example, the notification control unit 88) notifies the occupants in the vehicle of the arrival of the replacement vehicle X2 and the position of the replacement vehicle X2. After processing in S506, the flow proceeds to S507.

In S507, the HCU 100 (for example, the communication processing unit 85) transmits the information of the subject vehicle Am to the replacement vehicle X2. As a result, the information of the subject vehicle Am is transferred to the replacement vehicle X2. The series of processes ends with S507.

The communication processing unit 85 in the ninth embodiment corresponds to an “information transfer unit”.

According to the ninth embodiment described above, after the collision, a notification is performed to indicate the position of the replacement vehicle X2 according to the arrival of the replacement vehicle X2 used for transfer of the occupant from the subject vehicle Am. As a result, the occupant is possible to grasp the position of the replacement vehicle X2 and smoothly perform the transfer.

Additionally, according to the ninth embodiment, the replacement vehicle X2 is arranged in response to the occupant operating the emergency notification switch 29 provided in the subject vehicle Am. Since the arrangement of the replacement vehicle X2 can be easily performed, the occupant is possible to smoothly perform the transfer.

Furthermore, according to the ninth embodiment, the replacement vehicle X2 is a vehicle selected from available vehicles in the periphery of the collision site. By utilizing an available vehicle as the replacement vehicle X2, the occupant is possible to quickly perform the transfer.

Additionally, according to the ninth embodiment, when the occupants transfer to the replacement vehicle X2, information from the subject vehicle Am is transmitted to the replacement vehicle X2, and the information is transferred to the replacement vehicle X2. As a result, after the occupant has transferred to the replacement vehicle X2, the occupant is possible spend the time comfortably.

### Tenth Embodiment

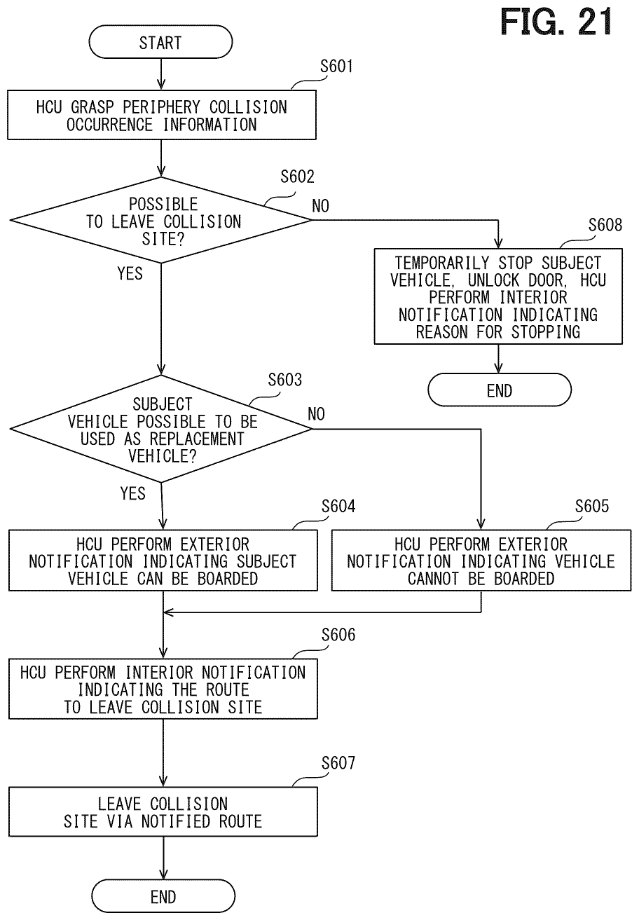

As shown in FIG. 21, a tenth embodiment is a modification of the first embodiment. The tenth embodiment will be described mainly focusing on configurations different from those of the first embodiment.

In the tenth embodiment, the collision recognition unit 74 of the automated driving ECU 50b further recognizes the occurrence of collisions between multiple other objects in the periphery of the subject vehicle Am. Here, the term of “periphery” may refer to a range in which the subject vehicle Am is recognized as being present at the site (hereinafter referred to as the collision site) where the collision occurred.

The collision recognition unit 74 recognizes collisions based on the images captured by the camera unit 31. The collision recognition unit 74 provides this information to the information coordination unit 61 as periphery collision occurrence information. As a result, the periphery collision occurrence information is grasped by the HCU 100.

The HCU 100 or the automated driving ECU 50b determines whether the vehicle can leave from the collision site based on the periphery collision occurrence situation. When this determination is performed by the HCU 100, the determination may be executed, for example, by the notification control unit 88. When this determination is performed by the automated driving ECU 50b, it may be executed, for example, by the collision recognition unit 74 or the behavior determination unit 63.

Based on this determination result, the behavior determination unit 63 changes the response related to automated driving control, and the notification control unit 88 changes the response related to notifications. In this manner, the HCU 100 and the automated driving ECU 50b cooperate to respond to collision occurrences in the periphery.

An example of the processing method by the vehicle system 1 of the tenth embodiment will be described with reference to the flowchart in FIG. 21. The series of processes indicated in S601 to S608 are implemented by at least one processor of the vehicle system 1 executing a program. This series of processes is preferably executed during automated driving when the driver is not obligated to monitor the periphery. This series of processes may be executed in correspondence with the processing of the automated driving ECU 50b in S11 to S13 of FIG. 4.

In S601, the HCU 100 acquires periphery collision occurrence information. After processing in S601, the flow proceeds to S602.

In S602, either the HCU 100 (for example, notification control unit 88) or the automated driving ECU 50b (for example, behavior determination unit 63) determines whether the subject vehicle Am can leave the collision site. In a case of Yes, the flow proceeds to S603. In a case of No, the flow proceeds to S608.

In S603, it is determined whether the subject vehicle Am can be used as the replacement vehicle. That is, when the other object involved in the collision is another vehicle, it is determined whether the occupant of the other vehicle can transfer to the subject vehicle Am. For example, when the occupant of the subject vehicle Am is only the driver and the passenger seat and rear seats are vacant, it is determined that the subject vehicle Am can be used as the replacement vehicle. When the passenger seat and rear seats are fully occupied, it is determined that the subject vehicle Am cannot be used as the replacement vehicle. In a case of Yes, the flow proceeds to S604. In a case of No, the flow proceeds to S605.

In S604, the HCU 100 (for example, the notification control unit 88) provides a notification to the outside of the vehicle indicating that the occupant is possible to get into the subject vehicle Am. Based on this notification, the boarding of occupant from the other vehicle into the subject vehicle Am is accepted. On the other hand, in S605, the HCU 100 (for example, the notification control unit 88) provides a notification to the outside of the vehicle, the notification indicating that the occupant is not possible to get into the subject vehicle Am. These vehicle exterior notifications may be performed using, for example, the exterior display device 28 described in the eighth embodiment, or may be implemented using voice through external speakers. After processing in S604 or S605, the flow proceeds to S606.

In S606, the HCU 100 (for example, the notification control unit 88) performs an internal notification indicating a driving route away from the collision site, using, for example, the CID. This driving route may be a route planned by the automated driving ECU 50b (for example, the behavior determination unit 63), or it may be a route derived by the navigation ECU 38. After processing S606, the flow proceeds to S607.

In S607, the automated driving ECU 50b (for example, the control execution unit 64) controls the subject vehicle Am to leave the collision site via the notified driving route. The series of processes ends with S607.

In S608, after it is determined in S602 that the subject vehicle Am cannot leave the collision site, the automated driving ECU 50b, for example, the behavior determination unit 63, first decides to temporarily stop the subject vehicle Am, and the control execution unit 64 temporarily stops the subject vehicle Am. Next, the behavior determination unit 63 or the notification control unit 88 decides to unlock the door and requests the body ECU 43, which controls the door lock motor 46, to unlock the door.

Furthermore, in response to the temporary stop of the subject vehicle Am, the HCU 100 (for example, the notification control unit 88) provides an in-vehicle notification indicating the reason for the stop of the subject vehicle Am, using, for example, the CID. Here, the notification indicating the reason for the stop may be a notification that the collision has occurred in the periphery of the subject vehicle Am and that the subject vehicle Am cannot leave the collision site.

It is also possible to skip the processes in S603 to S605 and execute the process such that if the answer in S602 is Yes, the flow proceeds to S606.

The automated driving ECU 50b in the tenth embodiment corresponds to an “automated driving device”.

According to the tenth embodiment described above, the periphery collision occurrence information, indicating the presence or absence of collisions between multiple other objects in the periphery of the subject vehicle Am, is further grasped. Then, the notification-related response is modified according to the determination of whether the subject vehicle Am can leave the collision site, based on the periphery collision occurrence information. Accordingly, it is possible to provide appropriate notifications based on whether the vehicle can leave the collision site.

Additionally, according to the tenth embodiment, periphery collision occurrence information indicating the presence or absence of collisions between multiple other objects in the periphery of the vehicle is further grasped. Then, when a collision between other objects occurs, an exterior notification indicating whether to be capable of boarding the subject vehicle Am is executed. Therefore, external road users are possible to determine their actions with the understanding of whether it is permissible to board the subject vehicle Am.

Additionally, according to the tenth embodiment, collisions between multiple different objects in the periphery of the vehicle are detected. Then, based on the determination of whether the subject vehicle Am can move away from the collision site, the response related to automated driving control is adjusted. Accordingly, it is possible to provide appropriate control based on whether the vehicle can leave from the collision site.

Additionally, according to the tenth embodiment, when it is determined that the subject vehicle Am cannot move away from the collision site, the subject vehicle Am temporary stops. It is possible to prevent confusion at the collision site caused by inappropriate behavior of the subject vehicle Am.

### Eleventh Embodiment

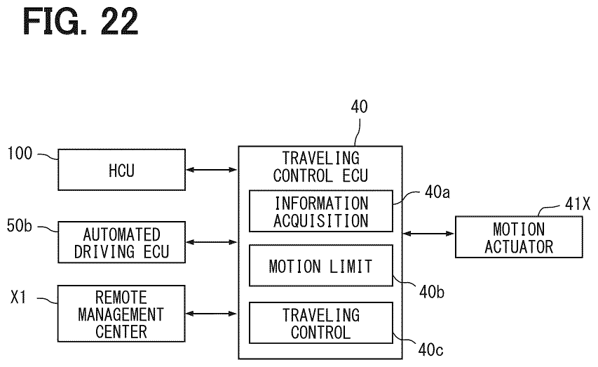

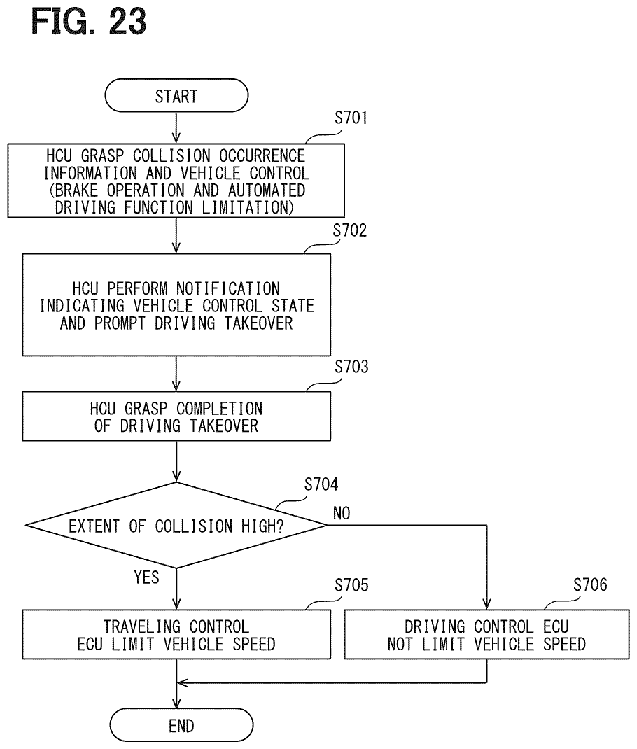

As shown in FIGS. 22 and 23, an eleventh embodiment is a modification of the first embodiment. The eleventh embodiment will be described mainly focusing on configurations different from those of the first embodiment.

A traveling control ECU 40X of the eleventh embodiment is an electronic control unit with an added function to limit the vehicle's motion, as compared to the traveling control ECU 40 of the vehicle system 1 shown in FIG. 1, and corresponds to the traveling control device.

The traveling control ECU 40X is a computer that primarily includes a control circuit equipped with a processing unit, RAM, a storage unit, input/output interfaces, and a bus connecting these components. The processing unit executes various processes to implement the automated driving control method of the present disclosure by accessing the RAM. The storage stores various programs (such as automated driving control programs) that are executed by the processing unit.

The processing unit may include at least one processor. The processor may include at least one type of core, such as a CPU (Central Processing Unit), GPU (Graphics Processing Unit), or RISC (Reduced Instruction Set Computer) CPU. The storage 53 may include at least one type of non-transitory tangible storage medium, such as a semiconductor memory, magnetic medium, or optical medium, for non-volatile storage of programs and data readable by the processor.

By executing the program with the processing unit, the traveling control ECU 40X is configured with multiple functional units to implement the travel control function, such as an information acquisition unit 40a, a motion limitation unit 40b, and a traveling control unit 40c (see FIG. 22).

The information acquisition unit 40a is configured to acquire information output from various in-vehicle devices of the vehicle system 1. The information acquisition unit 40a may further acquire information output from the remote management center X1 described in the ninth embodiment. The information referred to here also includes requests and instructions directed to the traveling control ECU 40X.

The motion limitation unit 40b limits the movement of the subject vehicle Am by imposing constraints on the operation commands or control instructions that the traveling control unit 40c outputs to a motion actuator 41X. The motion limitation unit 40b may determine the content of the limitations based on the information acquired by the information acquisition unit 40a. The motion limitation unit 40b may limits the movement of the subject vehicle Am in accordance with limitation requests from the in-vehicle devices of the vehicle system 1 or from the remote management center X.

The traveling control unit 40c continuously controls the motion actuator 41X based on one of an operation instruction based on the driver's driving operations, a control instructions from the driving assistance ECU 50a, a control instruction from the automated driving ECU 50b, and a control instruction from the remote management center X1. The motion actuator 41X may include a brake actuator that controls the braking force of each wheel, a powertrain that controls the output of the onboard power source, and a steering actuator that controls the steering angle.

An example of the processing method by the vehicle system 1 in the eleventh embodiment will be described with reference to a flowchart in FIG. 23. The series of processes shown in S701 to S706 are executed by at least one processor of the vehicle system 1 executing a program. This series of processes is preferably executed during automated driving when the driver is not required to monitor the periphery. This series of processes may be implemented in correspondence with the processing of the automated driving ECU 50b in S11 to S13 of FIGS. 4.

S701 to S703 are same as S101 to S103 in the second embodiment. After the processing of S703, the flow proceeds to S704.

In S704, the traveling control ECU 40X (for example, the information acquisition unit 40a) acquires processing information from the HCU 100 and the automated driving ECU 50b. Furthermore, the traveling control ECU 40X (for example, the motion limitation unit 40b) determines whether the extent of the collision that occurred is significant (i.e., exceeds a preset threshold). Specifically, the motion limitation unit 40b may determine whether the periphery monitoring sensor 30 has malfunctioned due to the collision. In a case of Yes, the flow proceeds to S705. In a case of No, the flow proceeds to S706.

In S705, the traveling control ECU 40X (for example, the motion limitation unit 40b) limits the speed of the subject vehicle Am to a predetermined maximum speed. The predetermined maximum speed may be a speed at which the subject vehicle Am can travel stably even when the vehicle body or the periphery monitoring sensor 30 has been damaged due to the collision. The maximum speed may be set, for example, to 10 km/h, 20 km/h, or the like. The maximum speed may be made to vary depending on the degree of the collision, gradually decreasing as the severity of the collision increases. The series of processes ends with S705.

In S705, the traveling control ECU 40X (for example, the motion limitation unit 40b) does not impose any speed limitations on the subject vehicle Am. In other words, the traveling control ECU 40X (for example, the motion limitation unit 40b) controls the motion actuator 41X to faithfully reproduce the vehicle motion as indicated by the operation command or control command. The series of processes ends with S705.

According to the eleventh embodiment described above, after a collision occurs, the motion of the subject vehicle Am is restricted in response to the collision. Thereby, it is possible to prevent inappropriate motions of the subject vehicle Am.

Additionally, according to the eleventh embodiment, when the extent of the collision exceeds a predetermined level, the speed of the subject vehicle Am is limited. The speed limitation helps to prevent secondary collisions and confusion at the collision site.

### Twelfth Embodiment

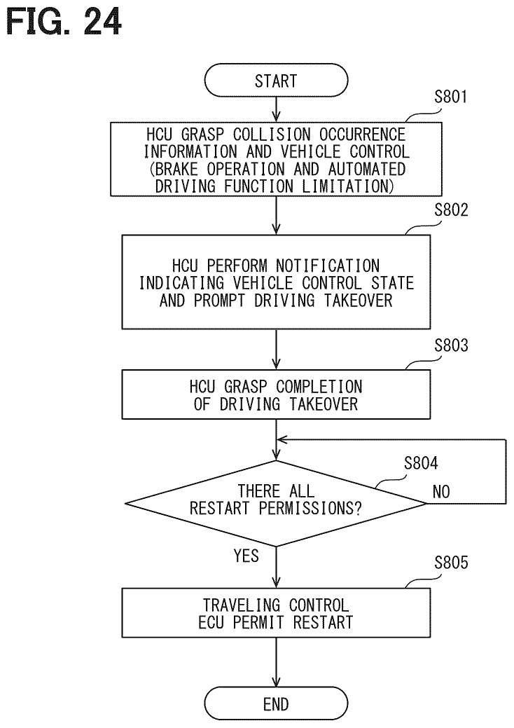

As shown in FIG. 24, the twelfth embodiment is a modification of the eleventh embodiment. The twelfth embodiment will be described mainly focusing on the differences from the eleventh embodiment.

In the twelfth embodiment, the motion limitation unit 40b prohibits the restart of the subject vehicle Am after a temporary stop due to a collision until all three predefined restart permissions are acquired. The first restart permission is granted by the occupant of the subject vehicle Am. This permission is obtained, for example, by the occupant operating a start permission switch installed in the subject vehicle Am. The second restart permission is granted by the remote management center X1. This permission is obtained, for example, by an operator at the remote management center X1 collecting information about the collision site via V2X communication or the like, and granting permission after confirming that a restart is possible.

The third restart permission is granted by the vehicle system 1 installed in the vehicle. This permission is obtained by a predetermined decision-making entity (ECU or processor) in the vehicle system 1 that grants permission after confirming that a restart is possible. The decision-making entity may be, for example, the automated driving ECU 50b, which has the authority to switch automated driving levels.

An example of the processing method by the vehicle system 1 in the twelfth embodiment will be described with reference to the flowchart in FIG. 24. The series of processes shown in steps S801 to S805 are executed by at least one processor of the vehicle system 1 executing the program. This series of processes is preferably executed during automated driving when the driver is not required to monitor the periphery. This series of processes should be executed in correspondence with the processing of the automated driving ECU 50b in S11 to S13 of FIGS. 4.

S801 to S803 are same as S701 to S703 in the eleventh embodiment. After the processing of S803, the flow proceeds to S804.

In S804, the traveling control ECU 40X (for example, the motion limitation unit 40b) maintains the restart prohibition state of the subject vehicle Am and determines whether all restart permissions have been obtained. In a case of Yes, the flow proceeds to S805. In a case of No, after a predetermined time or after a predetermined trigger occurs, the determination of S804 is performed again.

In S805, the traveling control ECU 40X (for example, the motion limitation unit 40b) cancels the prohibition of the restart of the subject vehicle Am and permits the restart. As a result, the traveling control ECU 40X (for example, the motion limitation unit 40b) can control the motion actuator 41X to reproduce the vehicle motion as instructed by the operation command or control instruction. The series of processes ends with S805.

In addition, after S805, the processes of S704 to S706 of the eleventh embodiment may be executed so that the speed of the subject vehicle Am is limited after the restart.

According to the twelfth embodiment described above, when the subject vehicle Am temporarily stops after a collision, the restart of the subject vehicle Am is prohibited until permission is obtained from all of the occupant of the subject vehicle Am, the remote management center X1 that manages the subject vehicle Am remotely, and the vehicle system 1 installed in the subject vehicle Am. By prohibiting inappropriate restart, it is possible to prevent secondary collisions and confusion at the collision site.

### Other Embodiments

As described above, multiple embodiments have been described, but the present disclosure is not to be interpreted as being limited to these embodiments. Various modifications and combinations can be applied within the scope that does not deviate from the gist of the present disclosure.

In other embodiments, the determination regarding driving takeover may be executed by an ECU other than the automated driving ECU 50b. For example, a separate state management ECU may be provided apart from the automated driving ECU 50b, and the state management ECU may manage the switching of the automated driving levels and driving takeover for the subject vehicle Am.

In other embodiments, when the operation device 26 is a touch panel integrated with the CID 22, the HCU 100 (for example, the notification control unit 88) may execute the following processes. This process may involve prohibiting (or erasing) the display of the interface itself for activating the limited automated driving function while the automated driving function is limited.

In other embodiments, when the subject vehicle Am is a bus, in response to the emergency release operation of the fourth embodiment, full opening control of all windows and full opening control of all boarding and alighting doors may be executed. Since buses may have windows installed at a high position, escape through the windows becomes difficult. Therefore, it is preferable to ensure that escape through the doors is possible.

In other embodiments, the determination in S203 may be omitted, and the process may proceed directly from S202 to S204.

Additionally, as an embodiment related to the seventh embodiment, when at least one of the notifications indicating post-collision accident handling guidance and the actions required of the occupants are executed in S204, the process may skip from S201 to S203 without executing the notification in S202.

In other embodiments, at least some of the functions of ECUs such as the HCU 100, the driving assistance ECU 50a, the automated driving ECU 50b, and the traveling control ECU 40 may be integrated into a single ECU or reorganized into multiple ECUs.

The control device and its methods described in the present disclosure may be implemented by a dedicated computer, which constitutes a processor programmed to execute one or more functions embodied by a computer program. Alternatively, the apparatus and its methods described in the present disclosure may be implemented by dedicated hardware logic circuits. Alternatively, the apparatus and its methods described in the present disclosure may be implemented by one or more dedicated computers composed of a combination of a processor executing a computer program and one or more hardware logic circuits. Additionally, the computer program may be stored on a computer-readable non-transitory tangible storage medium as instructions executed by a computer.

What is claimed is:

1. A control device configured to control an in-vehicle device in a vehicle capable of traveling by automated driving without a periphery monitoring obligation of a driver, the control device comprising:
at least one of (i) a circuit and (ii) a processor with a memory storing computer program code executable by the processor, the at least one of the circuit and the processor configured to cause the control device to: serve as
an information grasping unit configured to determine
collision occurrence information indicating presence or absence of a collision between the vehicle and a different object during the automated driving, and
vehicle control information indicating a state of a vehicle control of the vehicle after the vehicle control is performed according to the collision; and
a notification control unit configure to perform both of
a notification indicating a control state of the vehicle after the vehicle control is performed according to the collision and
a notification indicating that a system performs request or warning for driving takeover to the driver.

2. The control device according to claim 1, wherein
the notification indicating the control state of the vehicle after the vehicle control is performed according to the collision includes:
a notification indicating that movement of the vehicle has been restricted by brake activation; and
a notification indicating that a hazard light of the vehicle has been turned on.

3. The control device according to claim 1, wherein
when the information grasping unit determines that an automated driving function of the vehicle has been limited after an occurrence of the collision, the notification control unit performs a notification indicating that the automated driving function has been limited.

4. The control device according to claim 1, wherein
the information grasping unit is configured to determine an operation on an operation device of the vehicle to turn on an automated driving function, and
when the information grasping unit determines that the automated driving function of the vehicle has been limited after an occurrence of the collision and the operation to turn on the automated driving function has been performed, the notification control unit performs the notification indicating that the automated driving has been limited.

5. The control device according to claim 3, wherein
in the vehicle, release of limitation of the automated driving function is prohibited until a vehicle manager performs an initialization operation.

6. The control device according to claim 3, wherein
in the vehicle, release of limitation of the automated driving function is performed based on an on-state of an activation switch of the vehicle.

7. The control device according to claim 1, wherein
the notification control unit is further configured to perform a notification indicating a collision part of the vehicle.

8. The control device according to claim 7, wherein
the notification control unit is further configured to perform a notification indicating a malfunction associated with the collision part.

9. The control device according to claim 1, wherein
the notification control unit is further configured to perform a notification indicating a fire hazard possibility of the vehicle.

10. The control device according to claim 1, wherein
the notification control unit is further configured to perform a notification indicating a position on a road where the vehicle has stopped.

11. The control device according to claim 10, wherein
the notification indicating the position on the road where the vehicle has stopped includes information indicating, among a plurality of lanes of the road, a lane where the vehicle has stopped.

12. The control device according to claim 1, wherein
the at least one of the circuit and the processor is further configured to cause the control device to serve as a request processing unit configured to require the vehicle to change a door lock state of the vehicle to a state where an occupant of the vehicle is not capable of manually releasing a door lock of the vehicle when the occupant is not required to urgently exit the vehicle.

13. The control device according to claim 1, wherein
the information grasping unit is further configured to determine whether an emergency opening operation on an operation device of the vehicle has been performed, and
the at least one of the circuit and the processor is further configured to cause the control device to serve as a request processing unit configured to require the vehicle to fully open a side window of the vehicle when the information grasping unit determines that the emergency opening operation has been performed.

14. The control device according to claim 1, wherein
the notification control unit performs, as a notification that performs the request or the warning for the driving takeover to the driver, a notification that prompts driving takeover that is less urgent than driving takeover in a state where an automated driving function is limited, in response to determination of continuing the automated driving function in a case of determining whether to continue the automated driving performed under a preset condition according to an aspect of the collision.

15. The control device according to claim 14, wherein
the preset condition based on the aspect of the collision is a condition based on an extent of the condition and a malfunction state of a periphery monitoring sensor mounted on the vehicle.

16. The control device according to claim 14, wherein
the preset condition based on the aspect of the collision is a condition based on a collision part of the vehicle and the different object.

17. The control device according to claim 1, wherein the notification control unit is further configured to perform a notification having an information amount changed depending on a state of an occupant at a time of the collision.

18. The control device according to claim 17, wherein
when the occupant is in a sleeping state, the notification control unit performs a notification having the information amount larger than the information amount in a state where the occupant is performing a second task, and
when the occupant is performing the second task, the notification control unit performs a notification having the information amount larger than the information amount in a state where the occupant is monitoring a periphery of the vehicle.

19. The control device according to claim 18, wherein
the notification control unit performs a notification indicating a type of the different object when the occupant is not monitoring the periphery.

20. The control device according to claim 1, wherein
the notification control unit is configured to perform a notification indicating guidance for accident handling after the collision.

21. The control device according to claim 1, wherein
the notification control unit is further configured to perform a notification indicating an action required of an occupant of the vehicle after the collision.

22. The control device according to claim 1, wherein
the notification control unit is configured to perform a vehicle exterior notification that guides the different object that is a dynamic object for restarting traveling of the vehicle when the vehicle is capable of traveling after the collision.

23. The control device according to claim 1, wherein
the notification control unit is configured to perform a notification indicating a position of a replacement vehicle according to an arrival of the replacement vehicle to which an occupant of the vehicle transfers from the vehicle after the collision.

24. The control device according to claim 23, wherein
the replacement vehicle is arranged in response to an operation by the occupant on an emergency notification switch mounted on the vehicle.

25. The control device according to claim 23, wherein
the replacement vehicle is a vehicle selected from a vacant vehicle in a periphery of a collision site.

26. The control device according to claim 23, wherein
the at least one of the circuit and the processor is further configured to cause the control device to serve as an information transfer unit configured to transmit information of the vehicle to the replacement vehicle for transfer by the occupant to the replacement vehicle for information takeover.

27. The control device according to claim 1, wherein
the different object includes a plurality of different objects,
the information grasping unit is configured to further acquire periphery collision occurrence information indicating whether a collision between the plurality of different objects has occurred in a periphery of the vehicle, and
the notification control unit is configured to change a notification-related response depending on determination of whether the vehicle is capable of leaving a collision occurrence site, the determination being performed based on the periphery collision occurrence information.

28. The control device according to claim 1, wherein
the different object includes a plurality of different objects,
the information grasping unit is configured to further acquire periphery collision occurrence information indicating whether a collision between the plurality of different objects has occurred, and
the notification control unit performs a vehicle exterior notification indicating whether an occupant of the vehicle is capable of boarding the vehicle when the collision between the plurality of different objects has occurred.

29. An automated driving device configured to perform automated driving of a vehicle and communicate with the control device according to claim 27, wherein
the information grasping unit is configured to further acquire periphery collision occurrence information indicating whether a collision between the plurality of different objects has occurred, and
the notification control unit performs a vehicle exterior notification indicating whether an occupant of the vehicle is capable of boarding the vehicle when the collision between the plurality of different objects has occurred, and
the automated driving device includes: at least one of (i) another circuit and (ii) another processor with another memory storing another computer program code executable by the another processor, the at least one of the another circuit and the another processor configured to cause the automated driving device to: serve as
a collision recognition unit configured to recognize an occurrence of a collision between the plurality of different objects in a periphery of the vehicle; and
a behavior determination unit configured to change a response related to a control of the automated driving depending on determination of whether the vehicle is capable of leaving a collision occurrence site.

30. The automated driving device according to claim 29, wherein
the behavior determination unit is configured to temporarily stop the vehicle in response to determination that the vehicle is capable of leaving the collision occurrence site.

31. A traveling control device configured to control traveling of a vehicle and communicate with the control device according to claim 1, wherein
the different object includes a plurality of different objects, and
the traveling control device includes at least one of (i) another circuit and (ii) another processor with another memory storing another computer program code executable by the another processor, the at least one of the another circuit and the another processor configured to cause the traveling control device to serve as a motion limitation unit configured to limit motion of the vehicle in response to the collision after an occurrence of the collision.

32. The traveling control device according to claim 31, wherein
the motion limitation unit limits a speed of the vehicle when an extent of the collision exceeds a preset extent.

33. The traveling control device according to claim 31, wherein
the motion limitation unit prohibits a restart of the vehicle until all of: permission by an occupant of the vehicle; permission by a remote management center configured to remotely manage the vehicle; and permission by a system mounted in the vehicle, when the vehicle temporarily stops after the occurrence of the collision.
